(19) United States
(12) Patent Application Publication
(10) Pub. No.: US 2007/0230564 A1
(43) Pub. Date: Oct. 4, 2007

(54) VIDEO PROCESSING WITH SCALABILITY

(75) Inventors: Peisong Chen, San Diego, CA (US); Tao Tian, San Diego, CA (US); Fang Shi, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/562,360

(22) Filed: Nov. 21, 2006

Related U.S. Application Data
(60) Provisional application No. 60/787,310, filed on Mar. 29, 2006.
(60) Provisional application No. 60/789,320, filed on Apr. 4, 2006.
(60) Provisional application No. 60/833,445, filed on Jul. 25, 2006.

(51) Int. Cl. H04N 11/02

(52) U.S. Cl. 375/240.01

(57) ABSTRACT

In general, this disclosure describes video processing techniques that make use of syntax elements and semantics to support low complexity extensions for multimedia processing with video scalability. The syntax elements and semantics may be added to network abstraction layer (NAL) units and may be especially applicable to multimedia broadcasting, and define a bitstream format and encoding process that support low complexity video scalability. In some aspects, the techniques may be applied to implement low complexity video scalability extensions for devices that otherwise conform to the H.264 standard. For example, the syntax element and semantics may be applicable to NAL units conforming to the H.264 standard.

### CLAIM OF PRIORITY UNDER 35 U.S.C. §119

This application claims the benefit of U.S. Provisional Application Ser. No. 60/787,310, filed Mar. 29, 2006 (Attorney Docket No. 060961P1), U.S. Provisional Application Ser. No. 60/789,320, filed Mar. 29, 2006 (Attorney Docket No. 060961P2), and U.S. Provisional Application Ser. No. 60/833,445, filed Jul. 25, 2006 (Attorney Docket No. 061640), the entire content of each of which is incorporated herein by reference.

### TECHNICAL FIELD

This disclosure relates to digital video processing and, more particularly, techniques for scalable video processing.

### BACKGROUND

Digital video capabilities can be incorporated into a wide range of devices, including digital televisions, digital direct broadcast systems, wireless communication devices, personal digital assistants (PDAs), laptop computers, desktop computers, video game consoles, digital cameras, digital recording devices, cellular or satellite radio telephones, and the like. Digital video devices can provide significant improvements over conventional analog video systems in processing and transmitting video sequences.

Different video encoding standards have been established for encoding digital video sequences. The Moving Picture Experts Group (MPEG), for example, has developed a number of standards including MPEG-1, MPEG-2 and MPEG-4. Other examples include the International Telecommunication Union (ITU)-T H.263 standard, and the ITU-T H.264 standard and its counterpart, ISO/IEC MPEG-4, Part 10, i.e., Advanced Video Coding (AVC). These video encoding standards support improved transmission efficiency of video sequences by encoding data in a compressed manner.

### SUMMARY

In general, this disclosure describes video processing techniques that make use of syntax elements and semantics to support low complexity extensions for multimedia processing with video scalability. The syntax elements and semantics may be applicable to multimedia broadcasting, and define a bitstream format and encoding process that support low complexity video scalability.

The syntax element and semantics may be applicable to network abstraction layer (NAL) units. In some aspects, the techniques may be applied to implement low complexity video scalability extensions for devices that otherwise conform to the ITU-T H.264 standard. Accordingly, in some aspects, the NAL units may generally conform to the H.264 standard. In particular, NAL units carrying base layer video data may conform to the H.264 standard, while NAL units carrying enhancement layer video data may include one or more added or modified syntax elements.

In one aspect, the disclosure provides a method for transporting scalable digital video data, the method comprising including enhancement layer video data in a network abstraction layer (NAL) unit, and including one or more syntax elements in the NAL unit to indicate whether the NAL unit includes enhancement layer video data.

In another aspect, the disclosure provides an apparatus for transporting scalable digital video data, the apparatus comprising a network abstraction layer (NAL) unit module that includes encoded enhancement layer video data in a NAL unit, and includes one or more syntax elements in the NAL unit to indicate whether the NAL unit includes enhancement layer video data.

In a further aspect, the disclosure provides a processor for transporting scalable digital video data, the processor being configured to include enhancement layer video data in a network abstraction layer (NAL) unit, and include one or more syntax elements in the NAL unit to indicate whether the NAL unit includes enhancement layer video data.

In an additional aspect, the disclosure provides a method for processing scalable digital video data, the method comprising receiving enhancement layer video data in a network abstraction layer (NAL) unit, receiving one or more syntax elements in the NAL unit to indicate whether the NAL unit includes enhancement layer video data, and decoding the digital video data in the NAL unit based on the indication.

In another aspect, the disclosure provides an apparatus for processing scalable digital video data, the apparatus comprising a network abstraction layer (NAL) unit module that receives enhancement layer video data in a NAL unit, and receives one or more syntax elements in the NAL unit to indicate whether the NAL unit includes enhancement layer video data, and a decoder that decodes the digital video data in the NAL unit based on the indication.

In a further aspect, the disclosure provides a processor for processing scalable digital video data, the processor being configured to receive enhancement layer video data in a network abstraction layer (NAL) unit, receive one or more syntax elements in the NAL unit to indicate whether the NAL unit includes enhancement layer video data, and decode the digital video data in the NAL unit based on the indication.

The techniques described in this disclosure may be implemented in a digital video encoding and/or decoding apparatus in hardware, software, firmware, or any combination thereof If implemented in software, the software may be executed in a computer. The software may be initially stored as instructions, program code, or the like. Accordingly, the disclosure also contemplates a computer program product for digital video encoding comprising a computer-readable medium, wherein the computer-readable medium comprises codes for causing a computer to execute techniques and functions in accordance with this disclosure.

Additional details of various aspects are set forth in the accompanying drawings and the description below. Other features, objects and advantages will become apparent from the description and drawings, and from the claims.

### BRIEF DESCRIPTION OF DRAWINGS

FIG. 1 is a block diagram illustrating a digital multimedia broadcasting system supporting video scalability.

FIG. 2 is a diagram illustrating video frames within a base layer and enhancement layer of a scalable video bitstream.

FIG. 3 is a block diagram illustrating exemplary components of a broadcast server and a subscriber device in the digital multimedia broadcasting system of FIG. 1.

FIG. 4 is a block diagram illustrating exemplary components of a video decoder for a subscriber device.

FIG. 5 is a flow diagram illustrating decoding of base layer and enhancement layer video data in a scalable video bitstream.

FIG. 6 is a block diagram illustrating combination of base layer and enhancement layer coefficients in a video decoder for single layer decoding.

FIG. 7 is a flow diagram illustrating combination of base layer and enhancement layer coefficients in a video decoder.

FIG. 8 is a flow diagram illustrating encoding of a scalable video bitstream to incorporate a variety of exemplary syntax elements to support low complexity video scalability.

FIG. 9 is a flow diagram illustrating decoding of a scalable video bitstream to process a variety of exemplary syntax elements to support low complexity video scalability.

FIGS. 10 and 11 are diagrams illustrating the partitioning of macroblocks (MBs) and quarter-macroblocks for luma spatial prediction modes.

FIG. 12 is a flow diagram illustrating decoding of base layer and enhancement layer macroblocks (MBs) to produce a single MB layer.

FIG. 13 is a diagram illustrating a luma and chroma deblocking filter process.

FIG. 14 is a diagram illustrating a convention for describing samples across a 4×4 block horizontal or vertical boundary.

FIG. 15 is a block diagram illustrating an apparatus for transporting scalable digital video data.

FIG. 16 is a block diagram illustrating an apparatus for decoding scalable digital video data.

### DETAILED DESCRIPTION

Scalable video coding can be used to provide signal-to-noise ratio (SNR) scalability in video compression applications. Temporal and spatial scalability are also possible. For SNR scalability, as an example, encoded video includes a base layer and an enhancement layer. The base layer carries a minimum amount of data necessary for video decoding, and provides a base level of quality. The enhancement layer carries additional data that enhances the quality of the decoded video.

In general, a base layer may refer to a bitstream containing encoded video data which represents a first level of spatio-temporal-SNR scalability defined by this specification. An enhancement layer may refer to a bitstream containing encoded video data which represents the second level of spatio-temporal-SNR scalability defined by this specification. The enhancement layer bitstream is only decodable in conjunction with the base layer, i.e. it contains references to the decoded base layer video data which are used to generate the final decoded video data.

Using hierarchical modulation on the physical layer, the base layer and enhancement layer can be transmitted on the same carrier or subcarriers but with different transmission characteristics resulting in different packet error rate (PER). The base layer has a lower PER for more reliable reception throughout a coverage area. The decoder may decode only the base layer or the base layer plus the enhancement layer if the enhancement layer is reliably received and/or subject to other criteria.

In general, this disclosure describes video processing techniques that make use of syntax elements and semantics to support low complexity extensions for multimedia processing with video scalability. The techniques may be especially applicable to multimedia broadcasting, and define a bitstream format and encoding process that support low complexity video scalability. In some aspects, the techniques may be applied to implement low complexity video scalability extensions for devices that otherwise conform to the H.264 standard. For example, extensions may represent potential modifications for future versions or extensions of the H.264 standard, or other standards.

The H.264 standard was developed by the ITU-T Video Coding Experts Group and the ISO/IEC Moving Picture Experts Group (MPEG), as the product of partnership known as the Joint Video Team (JVT). The H.264 standard is described in ITU-T Recommendation H.264, Advanced video coding for generic audiovisual services, by the ITU-T Study Group, and dated 03/2005, which may be referred to herein as the H.264 standard or H.264 specification, or the H.264/AVC standard or specification.

The techniques described in this disclosure make use of enhancement layer syntax elements and semantics designed to promote efficient processing of base layer and enhancement layer video by a video decoder. A variety of syntax elements and semantics will be described in this disclosure, and may be used together or separately on a selective basis. Low complexity video scalability provides for two levels of spatio-temporal-SNR scalability by partitioning the bitstream into two types of syntactical entities denoted as the base layer and the enhancement layer.

The coded video data and scalable extensions are carried in network abstraction layer (NAL) units. Each NAL unit is a network transmission unit that may take the form of a packet that contains an integer number of bytes. NAL units carry either base layer data or enhancement layer data. In some aspects of the disclosure, some of the NAL units may substantially conform to the H.264/AVC standard. However, various principles of the disclosure may be applicable to other types of NAL units. In general, the first byte of a NAL unit includes a header that indicates the type of data in the NAL unit. The remainder of the NAL unit carries payload data corresponding to the type indicated in the header. The header nal_unit_type is a five-bit value that indicates one of thirty-two different NAL unit types, of which nine are reserved for future use. Four of the nine reserved NAL unit types are reserved for scalability extension. An application specific nal_uni_type may be used to indicate that a NAL unit is an application specific NAL unit that may include enhancement layer video data for use in scalability applications.

The base layer bitstream syntax and semantics in a NAL unit may generally conform to an applicable standard, such as the H.264 standard, possibly subject to some constraints. As example constraints, picture parameter sets may have MbaffFRameFlag equal to 0, sequence parameter sets may have frame_mbs_only_flag equal to 1, and stored B pictures flag may be equal to 0. The enhancement layer bitstream syntax and semantics for NAL units are defined in this disclosure to efficiently support low complexity extensions for video scalability. For example, the semantics of network abstraction layer (NAL) units carrying enhancement layer data can be modified, relative to H.264, to introduce new NAL unit types that specify the type of raw bit sequence payload (RBSP) data structure contained in the enhancement layer NAL unit.

The enhancement layer NAL units may carry syntax elements with a variety of enhancement layer indications to aid a video decoder in processing the NAL unit. The various indications may include an indication of whether the NAL unit includes intra-coded enhancement layer video data at the enhancement layer, an indication of whether a decoder should use pixel domain or transform domain addition of the enhancement layer video data with the base layer data, and/or an indication of whether the enhancement layer video data includes any residual data relative to the base layer video data.

The enhancement layer NAL units also may carry syntax elements indicating whether the NAL unit includes a sequence parameter, a picture parameter set, a slice of a reference picture or a slice data partition of a reference picture. Other syntax elements may identify blocks within the enhancement layer video data containing non-zero transform coefficient values, indicate a number of nonzero coefficients in intra-coded blocks in the enhancement layer video data with a magnitude larger than one, and indicate coded block patterns for inter-coded blocks in the enhancement layer video data. The information described above may be useful in supporting efficient and orderly decoding.

The techniques described in this disclosure may be used in combination with any of a variety of predictive video encoding standards, such as the MPEG-1, MPEG-2, or MPEG-4 standards, the ITU H.263 or H.264 standards, or the ISO/IEC MPEG-4, Part 10 standard, i.e., Advanced Video Coding (AVC), which is substantially identical to the H.264 standard. Application of such techniques to support low complexity extensions for video scalability associated with the H.264 standard will be described herein for purposes of illustration. Accordingly, this disclosure specifically contemplates adaptation, extension or modification of the H.264 standard, as described, herein, to provide low complexity video scalability, but may also be applicable to other standards.

In some aspects, this disclosure contemplates application to Enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” to be published as Technical Standard TIA-1099 (the “FLO Specification”). The FLO Specification includes examples defining bitstream syntax and semantics and decoding processes suitable for delivering services over the FLO Air Interface.

As mentioned above, scalable video coding provides two layers: a base layer and an enhancement layer. In some aspects, multiple enhancement layers providing progressively increasing levels of quality, e.g., signal to noise ratio scalability, may be provided. However, a single enhancement layer will be described in this disclosure for purposes of illustration. By using hierarchical modulation on the physical layer, a base layer and one or more enhancement layers can be transmitted on the same carrier or subcarriers but with different transmission characteristics resulting in different packet error rate (PER). The base layer has the lower PER. The decoder may then decode only the base layer or the base layer plus the enhancement layer depending upon their availability and/or other criteria.

If decoding is performed in a client device such as a mobile handset, or other small, portable device, there may be limitations due to computational complexity and memory requirements. Accordingly, scalable encoding can be designed in such a way that the decoding of the base plus the enhancement layer does not significantly increase the computational complexity and memory requirement compared to single layer decoding. Appropriate syntax elements and associated semantics may support efficient decoding of base and enhancement layer data.

As an example of a possible hardware implementation, a subscriber device may comprise a hardware core with three modules: a motion estimation module to handle motion compensation, a transform module to handle dequantization and inverse transform operations, and a deblocking module to handle deblocking of the decoded video. Each module may be configured to process one macroblock (MB) at a time. However, it may be difficult to access the substeps of each module.

For example, the inverse transform of the luminance of an inter-MB may be on a 4×4 block basis and 16 transforms may be done sequentially for all 4×4 blocks in the transform module. Furthermore, pipelining of the three modules may be used to speed up the decoding process. Therefore, interruptions to accommodate processes for scalable decoding could slow down execution flow.

In a scalable encoding design, in accordance with one aspect of this disclosure, at the decoder, the data from the base and enhancement layers can be combined into a single layer, e.g., in a general purpose microprocessor. In this manner, the incoming data emitted from the microprocessor looks like a single layer of data, and can be processed as a single layer by the hardware core. Hence, in some aspects, the scalable decoding is transparent to the hardware core. There may be no need to reschedule the modules of the hardware core. Single layer decoding of the base and enhancement layer data may add, in some aspects, only a small amount of complexity in decoding and little or no increase on memory requirement.

When the enhancement layer is dropped because of high PER or for some other reason, only base layer data is available. Therefore, conventional single layer decoding can be performed on the base layer data and, in general, little or no change to conventional non-scalable decoding may be required. If both the base layer and enhancement layer of data are available, however, the decoder may decode both layers and generate an enhancement layer-quality video, increasing the signal-to-noise ratio of the resulting video for presentation on a display device.

In this disclosure, a decoding procedure is described for the case when both the base layer and the enhancement layer have been received and are available. However, it should be apparent to one skilled in the art that the decoding procedure described is also applicable to single layer decoding of the base layer alone. Also, scalable decoding and conventional single (base) layer decoding may share the same hardware core. Moreover, the scheduling control within the hardware core may require little or no modification to handle both base layer decoding and base plus enhancement layer decoding.

Some of the tasks related to scalable decoding may be performed in a general purpose microprocessor. The work may include two layer entropy decoding, combining two layer coefficients and providing control information to a digital signal processor (DSP). The control information provided to the DSP may include QP values and the number of nonzero coefficients in each 4×4 block. QP values may be sent to the DSP for dequantization, and may also work jointly with the nonzero coefficient information in the hardware core for deblocking. The DSP may access units in a hardware core to complete other operations. However, the techniques described in this disclosure need not be limited to any particular hardware implementation or architecture.

In this disclosure, bidirectional predictive (B) frames may be encoded in a standard way, assuming that B frames could be carried in both layers. The disclosure generally focuses on the processing of I and P frames and/or slices, which may appear in either the base layer, the enhancement layer, or both. In general, the disclosure describes a single layer decoding process that combines operations for the base layer and enhancement layer bitstreams to minimize decoding complexity and power consumption.

As an example, to combine the base layer and enhancement layer, the base layer coefficients may be converted to the enhancement layer SNR scale. For example, the base layer coefficients may be simply multiplied by a scale factor. If the quantization parameter (QP) difference between the base layer and the enhancement layer is a multiple of 6, for example, the base layer coefficients may be converted to the enhancement layer scale by a simple bit shifting operation. The result is a scaled up version of the base layer data that can be combined with the enhancement layer data to permit single layer decoding of both the base layer and enhancement layer on a combined basis as if they resided within a common bitstream layer.

By decoding a single layer rather than two different layers on an independent basis, the necessary processing components of the decoder can be simplified, scheduling constraints can be relaxed, and power consumption can be reduced. To permit simplified, low complexity scalability, the enhancement layer bitstream NAL units include various syntax elements and semantics designed to facilitate decoding so that the video decoder can respond to the presence of both base layer data and enhancement layer data in different NAL units. Example syntax elements, semantics, and processing features will be described below with reference to the drawings.

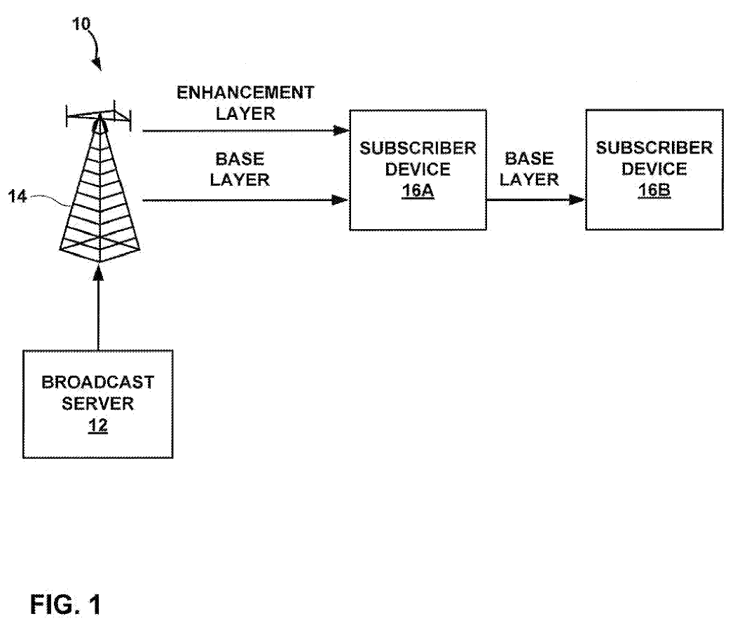

FIG. 1 is a block diagram illustrating a digital multimedia broadcasting system 10 supporting video scalability. In the example of FIG. 1, system 10 includes a broadcast server 12, a transmission tower 14, and multiple subscriber devices 16A, 16B. Broadcast server 12 obtains digital multimedia content from one or more sources, and encodes the multimedia content, e.g., according to any of video encoding standards described herein, such as H.264. The multimedia content encoded by broadcast server 12 may be arranged in separate bitstreams to support different channels for selection by a user associated with a subscriber device 16. Broadcast server 12 may obtain the digital multimedia content as live or archived multimedia from different content provider feeds.

Broadcast server 12 may include or be coupled to a modulator/transmitter that includes appropriate radio frequency (RF) modulation, filtering, and amplifier components to drive one or more antennas associated with transmission tower 14 to deliver encoded multimedia obtained from broadcast server 12 over a wireless channel. In some aspects, broadcast server 12 may be generally configured to deliver real-time video services in a terrestrial mobile multimedia multicast (TM3) systems according to the FLO Specification. The modulator/transmitter may transmit multimedia data according to any of a variety of wireless communication techniques such as code division multiple access (CDMA), time division multiple access (TDMA), frequency divisions multiple access (FDMA), orthogonal frequency division multiplexing (OFDM), or any combination of such techniques.

Each subscriber device 16 may reside within any device capable of decoding and presenting digital multimedia data, digital direct broadcast system, a wireless communication device, such as cellular or satellite radio telephone, a personal digital assistant (PDA), a laptop computer, a desktop computer, a video game console, or the like. Subscriber devices 16 may support wired and/or wireless reception of multimedia data. In addition, some subscriber devices 16 may be equipped to encode and transmit multimedia data, as well as support voice and data applications, including video telephony, video streaming and the like.

To support scalable video, broadcast server 12 encodes the source video to produce separate base layer and enhancement layer bitstreams for multiple channels of video data. The channels are transmitted generally simultaneously such that a subscriber device 16A, 16B can select a different channel for viewing at any time. Hence, a subscriber device 16A, 16B, under user control, may select one channel to view sports and then select another channel to view the news or some other scheduled programming event, much like a television viewing experience. In general, each channel includes a base layer and an enhancement layer, which are transmitted at different PER levels.

In the example of FIG. 1, two subscriber devices 16A, 16B are shown. However, system 10 may include any number of subscriber devices 16A, 16B within a given coverage area. Notably, multiple subscriber devices 16A, 16B may access the same channels to view the same content simultaneously. FIG. 1 represents positioning of subscriber devices 16A and 16B relative to transmission tower 14 such that one subscriber device 16A is closer to the transmission tower and the other subscriber device 16B is further away from the transmission tower. Because the base layer is encoded at a lower PER, it should be reliably received and decoded by any subscriber device 16 within an applicable coverage area. As shown in FIG. 1, both subscriber devices 16A, 16B receive the base layer. However, subscriber 16B is situated further away from transmission tower 14, and does not reliably receive the enhancement layer.

The closer subscriber device 16A is capable of higher quality video because both the base layer and enhancement layer data are available, whereas subscriber device 16B is capable of presenting only the minimum quality level provided by the base layer data. Hence, the video obtained by subscriber devices 16 is scalable in the sense that the enhancement layer can be decoded and added to the base layer to increase the signal to noise ratio of the decoded video. However, scalability is only possible when the enhancement layer data is present. As will be described, when the enhancement layer data is available, syntax elements and semantics associated with enhancement layer NAL units aid the video decoder in a subscriber device 16 to achieve video scalability. In this disclosure, and particularly in the drawings, the term “enhancement” may be shortened to “enh” or “ENH” for brevity.

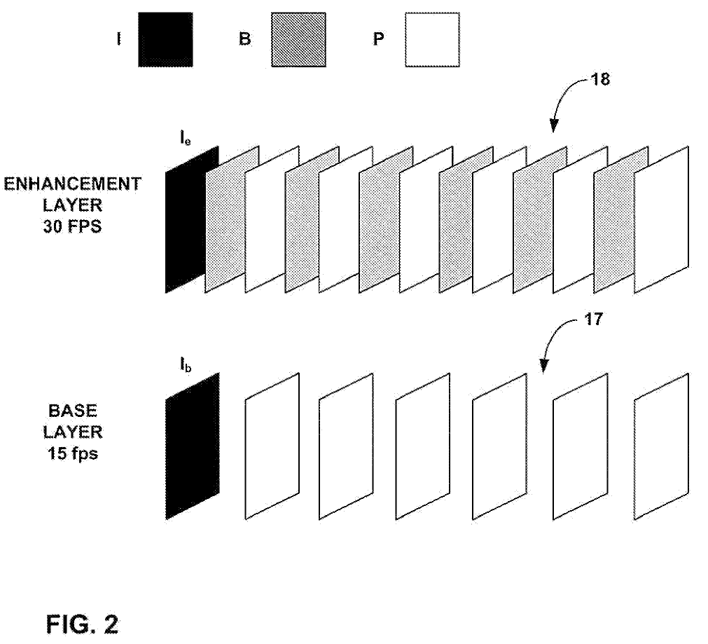

FIG. 2 is a diagram illustrating video frames within a base layer 17 and enhancement layer 18 of a scalable video bitstream. Base layer 17 is a bitstream containing encoded video data that represents the first level of spatio-temporal-SNR scalability. Enhancement layer 18 is a bitstream containing encoded video data that represents a second level of spatio-temporal-SNR scalability. In general, the enhancement layer bitstream is only decodable in conjunction with the base layer, and is not independently decodable. Enhancement layer 18 contains references to the decoded video data in base layer 17. Such references may be used either in the transform domain or pixel domain to generate the final decoded video data.

Base layer 17 and enhancement layer 18 may contain intra (I), inter (P), and bidirectional (B) frames. The P frames in enhancement layer 18 rely on references to P frames in base layer 17. By decoding frames in enhancement layer 18 and base layer 17, a video decoder is able to increase the video quality of the decoded video. For example, base layer 17 may include video encoded at a minimum frame rate of 15 frames per second, whereas enhancement layer 18 may include video encoded at a higher frame rate of 30 frames per second. To support encoding at different quality levels, base layer 17 and enhancement layer 18 may be encoded with a higher quantization parameter (QP) and lower QP, respectively.

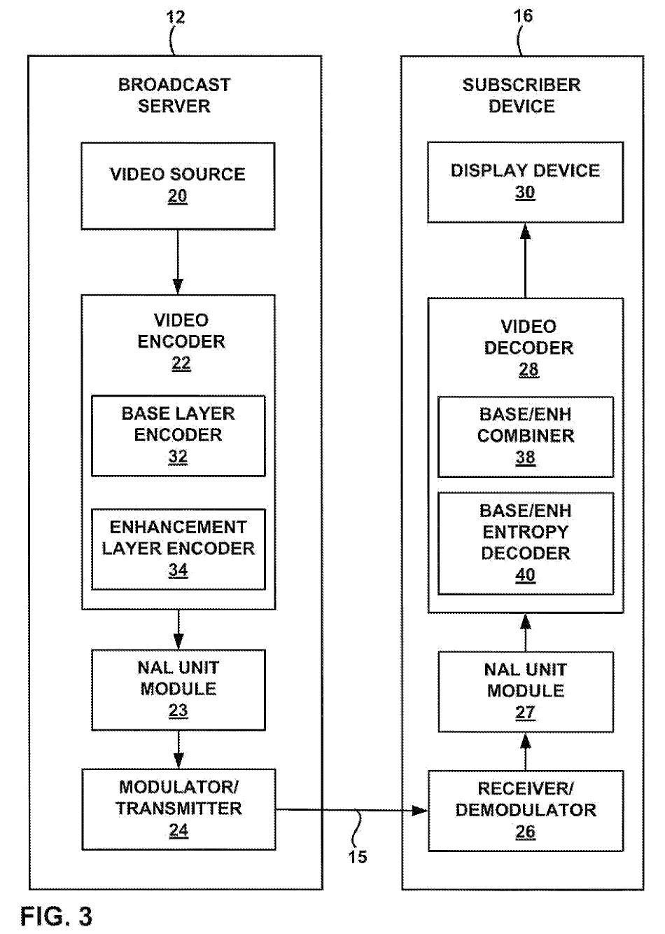

FIG. 3 is a block diagram illustrating exemplary components of a broadcast server 12 and a subscriber device 16 in digital multimedia broadcasting system 10 of FIG. 1. As shown in FIG. 3, broadcast server 12 includes one or more video sources 20, or an interface to various video sources. Broadcast server 12 also includes a video encoder 22, a NAL unit module 23 and a modulator/transmitter 24. Subscriber device 16 includes a receiver/demodulator 26, a NAL unit module 27, a video decoder 28 and a video display device 30. Receiver/demodulator 26 receives video data from modulator/transmitter 24 via a communication channel 15. Video encoder 22 includes a base layer encoder module 32 and an enhancement layer encoder module 34. Video decoder 28 includes a base layer/enhancement (base/enh) layer combiner module 38 and a base layer/enhancement layer entropy decoder 40.

Base layer encoder 32 and enhancement layer encoder 34 receive common video data. Base layer encoder 32 encodes the video data at a first quality level. Enhancement layer encoder 34 encodes refinements that, when added to the base layer, enhance the video to a second, higher quality level. NAL unit module 23 processes the encoded bitstream from video encoder 22 and produces NAL units containing encoded video data from the base and enhancement layers. NAL unit module 23 may be a separate component as shown in FIG. 3 or be embedded within or otherwise integrated with video encoder 22. Some NAL units carry base layer data while other NAL units carry enhancement layer data. In accordance with this disclosure, at least some of the NAL units include syntax elements and semantics to aid video decoder 28 in decoding the base and enhancement layer data without substantial added complexity. For example, one or more syntax elements that indicate the presence of enhancement layer video data in a NAL unit may be provided in the NAL unit that includes the enhancement layer video data, a NAL unit that includes the base layer video data, or both.

Modulator/transmitter 24 includes suitable modem, amplifier, filter, frequency conversion components to support modulation and wireless transmission of the NAL units produced by NAL unit module 23. Receiver/demodulator 26 includes suitable modem, amplifier, filter and frequency conversion components to support wireless reception of the NAL units transmitted by broadcast server. In some aspects, broadcast server 12 and subscriber device 16 may be equipped for two-way communication, such that broadcast server 12, subscriber device 16, or both include both transmit and receive components, and are both capable of encoding and decoding video. In other aspects, broadcast server 12 may be a subscriber device 16 that is equipped to encode, decode, transmit and receive video data using base layer and enhancement layer encoding. Hence, scalable video processing for video transmitted between two or more subscriber devices is also contemplated.

NAL unit module 27 extracts syntax elements from the received NAL units and provides associated information to video decoder 28 for use in decoding base layer and enhancement layer video data. NAL unit module 27 may be a separate component as shown in FIG. 3 or be embedded within or otherwise integrated with video decoder 28. Base layer/enhancement layer entropy decoder 40 applies entropy decoding to the received video data. If enhancement layer data is available, base layer/enhancement layer combiner module 38 combines coefficients from the base layer and enhancement layer, using indications provided by NAL unit module 27, to support single layer decoding of the combined information. Video decoder 28 decodes the combined video data to produce output video to drive display device 30. The syntax elements present in each NAL unit, and the semantics of the syntax elements, guide video decoder 28 in the combination and decoding of the received base layer and enhancement layer video data.

Various components in broadcast server 12 and subscriber device 16 may be realized by any suitable combination of hardware, software, and firmware. For example, video encoder 22 and NAL unit module 23, as well as NAL unit module 27 and video decoder 28, may be realized by one or more general purpose microprocessors, digital signal processors (DSPs), hardware cores, application specific integrated circuits (ASICs), field programmable gate arrays (FPGAs), or any combination thereof. In addition, various components may be implemented within a video encoder-decoder (CODEC). In some cases, some aspects of the disclosed techniques may be executed by a DSP that invokes various hardware components in a hardware core to accelerate the encoding process.

For aspects in which functionality is implemented in software, such as functionality executed by a processor or DSP, the disclosure also contemplates a computer-readable medium comprising codes within a computer program product. When executed in a machine, the codes cause the machine to perform one or more aspects of the techniques described in this disclosure. The machine readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, and the like.

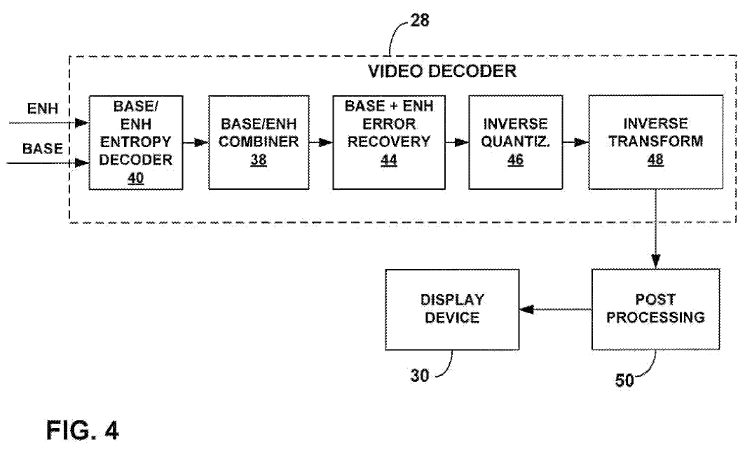

FIG. 4 is a block diagram illustrating exemplary components of a video decoder 28 for a subscriber device 16. In the example of FIG. 4, as in FIG. 3, video decoder 28 includes base layer/enhancement layer entropy decoder module 40 and base layer/enhancement layer combiner module 38. Also shown in FIG. 4 are a base layer plus enhancement layer error recovery module 44, and inverse quantization module 46, and an inverse transform and prediction module 48. FIG. 4 also shows a post processing module 50 that receives the output of video decoder 28 and display device 30.

Base layer/enhancement layer entropy decoder 40 applies entropy decoding to the video data received by video decoder 28. Base layer/enhancement layer combiner module 38 combines base layer and enhancement layer video data for a given frame or macroblock when the enhancement layer data is available, i.e., when enhancement layer data has been successfully received. As will be described, base layer/enhancement layer combiner module 38 may first determine, based on the syntax elements present in a NAL unit, whether the NAL unit contains enhancement layer data. If so, combiner module 38 combines the base layer data for a corresponding frame with the enhancement layer data, e.g., by scaling the base layer data. In this manner, combiner module 38 produces a single layer bitstream that can be decoded by video decoder 28 without processing multiple layers. Other syntax elements and associated semantics in the NAL unit may specify the manner in which the base and enhancement layer data is combined and decoded.

Error recovery module 44 corrects errors within the decoded output of combiner module 38. Inverse quantization module 46 and inverse transform module 48 apply inverse quantization and inverse transform functions, respectively, to the output of error recovery module 44, producing decoded output video for post processing module 50. Post processing module 50 may perform any of a variety of video enhancement functions such as deblocking, deringing, smoothing, sharpening, or the like. When the enhancement layer data is present for a frame or macroblock, video decoder 28 is able to produce higher quality video for application to post processing module 50 and display device 30. If enhancement layer data is not present, the decoded video is produced at a minimum quality level provided by the base layer.

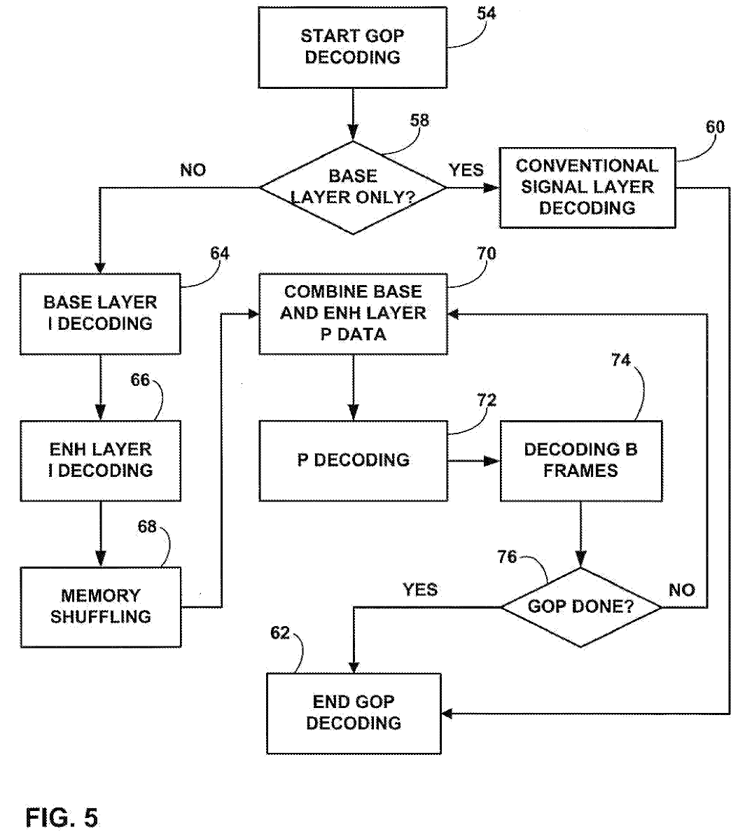

FIG. 5 is a flow diagram illustrating decoding of base layer and enhancement layer video data in a scalable video bitstream. In general, when the enhancement layer is dropped because of high packet error rate or is not received, only base layer data is available. Therefore, conventional single layer decoding will be performed. If both base and enhancement layers of data are available, however, video decoder 28 will decode both layers and generate enhancement layer-quality video. As shown in FIG. 5, upon the start of decoding of a group of pictures (GOP) (54), NAL unit module 27 determines whether incoming NAL units include enhancement layer data or base layer data only (58). If the NAL units include only base layer data, video decoder 28 applies conventional single layer decoding to the base layer data (60), and continues to the end of the GOP (62).

If the NAL units do not include only base layer data (58), i.e., some of the NAL nits include enhancement layer data, video decoder 28 performs base layer I decoding (64) and enhancement (ENH) layer I decoding (66). In particular, video decoder 28 decodes all I frames in the base layer and the enhancement layer. Video decoder 28 performs memory shuffling (68) to manage the decoding of I frames for both the base layer and the enhancement layer. In effect, the base and enhancement layers provide two I frames for a single I frame, i.e., an enhancement layer I frame Iₑ and a base layer I frame I_{b}. For this reason, memory shuffling may be used.

To decode an I frame when data from both layers is available, a two pass decoding may be implemented that works generally as follows. First, the base layer frame I_{b} is reconstructed as an ordinary I frame. Then, the enhancement layer I frame is reconstructed as a P frame. The reference frame for the reconstructed enhancement layer P frame is the reconstructed base layer I frame. All the motion vectors are zero in the resulting P frame. Accordingly, decoder 28 decodes the reconstructed frame as a P frame with zero motion vectors, making scalability transparent.

Compared to single layer decoding, decoding an enhancement layer I frame Iₑ is generally equivalent to the decoding time of a conventional I frame and P frame. If the frequency of I frames is not larger than one frame per second, the extra complexity is not significant. If the frequency is more than one I frame per second, e.g., due to scene change or some other reason, the encoding algorithm be configured to ensure that those designated I frames are only encoded at the base layer.

If the existence of both I_{b} and Iₑ at the decoder at the same time is affordable, Iₑ can be saved at a frame buffer different from I_{b}. This way, when Iₑ is reconstructed as a P frame, the memory indices can be shuffled and the memory occupied by I_{b} can be released. The decoder 28 then handles the memory index shuffling based on whether there is an enhancement layer bitstream. If the memory budget is too tight to allow for this, the process can overwrite Iₑ over I_{b} since all motion vectors are zero.

After decoding the I frames (64, 66) and memory shuffling (68), combiner module 38 combines the base layer and enhancement layer P frame data into a single layer (70). Inverse quantization module 46 and inverse transform module 48 then decode the single P frame layer (72). In addition, inverse quantization module 46 and inverse transform module 48 decode B frames (74).

Upon decoding the P frame data (72) and B frame data (74), the process terminates (62) if the GOP is done (76). If the GOP is not yet fully decoded, then the process continues through another iteration of combining base layer and enhancement layer P frame data (70), decoding the resulting single layer P frame data (72), and decoding the B frames (74). This process continues until the end of the GOP has been reached (76), at which time the process is terminated.

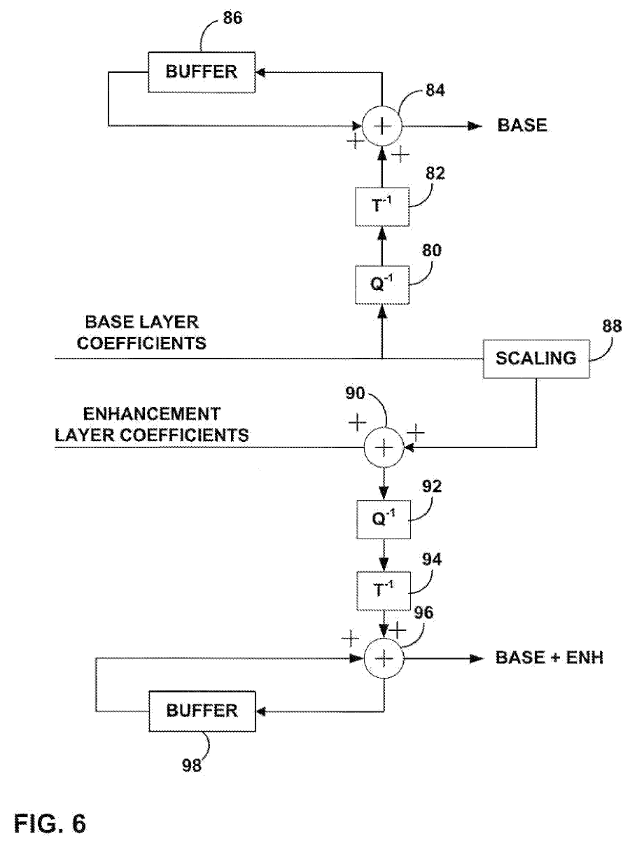

FIG. 6 is a block diagram illustrating combination of base layer and enhancement layer coefficients in video decoder 28. As shown in FIG. 6, base layer P frame coefficients are subjected to inverse quantization 80 and inverse transformation 82, e.g., by inverse quantization module 46 and inverse transform and prediction module 48, respectively (FIG. 4), and then summed by adder 84 with residual data from buffer 86, representing a reference frame, to produce the decoded base layer P frame output. If enhancement layer data is available, however, the base layer coefficients are subjected to scaling (88) to match the quality level of the enhancement layer coefficients.

Then, the scaled base layer coefficients and the enhancement layer coefficients for a given frame are summed in adder 90 to produce combined base layer/enhancement layer data. The combined data is subjected to inverse quantization 92 and inverse transformation 94, and then summed by adder 96 with residual data from buffer 98. The output is the combined decoded base and enhancement layer data, which produces an enhanced quality level relative to the base layer, but may require only single layer processing.

In general, the base and enhancement layer buffers 86 and 98 may store the reconstructed reference video data specified by configuration files for motion compensation purposes. If both base and enhancement layer bitstreams are received, simply scaling the base layer DCT coefficients and summing them with the enhancement layer DCT coefficients can support a single layer decoding in which only a single inverse quantization and inverse DCT operation is performed for two layers of data.

In some aspects, scaling of the base layer data may be accomplished by a simple bit shifting operation. For example, if the quantization parameter (QP) of the base layer is six levels greater than the QP of the enhancement layer, i.e., if QP_{b}−QPₑ=6, the combined base layer and enhancement layer data can be expressed as:

Cₑₙₕ′=Qₑ⁻¹((C_{base}<<1)+Cₑₙₕ)

where Cₑₙₕ′ represents the combined coefficient after scaling the base layer coefficient C_{base} and adding it to the original enhancement layer coefficient Cₑₙₕ, and Qₑ⁻¹ represents the inverse quantization operation applied to the enhancement layer.

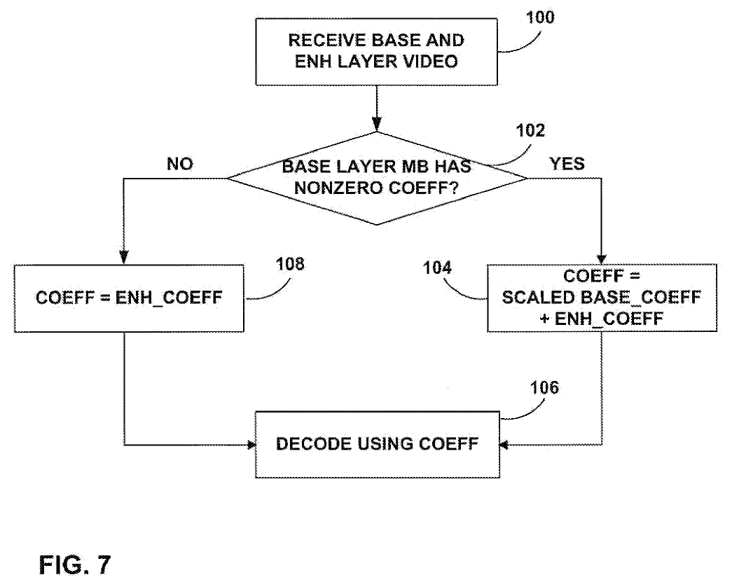

FIG. 7 is a flow diagram illustrating combination of base layer and enhancement layer coefficients in a video decoder. As shown in FIG. 7, NAL unit module 27 determines when both base layer video data and enhancement layer video data are received by subscriber device 16 (100), e.g., by reference to NAL unit syntax elements indicating NAL unit extension type. If base and enhancement layer video data is received, NAL unit module 27 also inspects one or more additional syntax elements within a given NAL unit to determine whether each base macroblock (MB) has any nonzero coefficients (102). If so (YES branch of 102), combiner 28 converts the enhancement layer coefficients to be a sum of the existing enhancement layer coefficients for the respective co-located MB plus the up-scaled base layer coefficients for the co-located MB (104).

In this case, the coefficients for inverse quantization module 46 and inverse transform module 48 are the sum of the scaled base layer coefficients and the enhancement layer coefficients as represented by COEFF=SCALED BASE_COEFF+ENH_COEFF (104). In this manner, combiner 38 combines the enhancement layer and base layer data into a single layer for inverse quantization module 46 and inverse transform module 48 of video decoder 28. If the base layer MB co-located with the enhancement layer does not have any nonzero coefficients (NO branch of 102), then the enhancement layer coefficients are not summed with any base layer coefficients. Instead, the coefficients for inverse quantization module 46 and inverse transform module 48 are the enhancement layer coefficients, as represented by COEFF=ENH_COEFF (108). Using either the enhancement layer coefficients (108) or the combined base layer and enhancement layer coefficients (104), inverse quantization module 46 and inverse transform module 48 decode the MB (106).

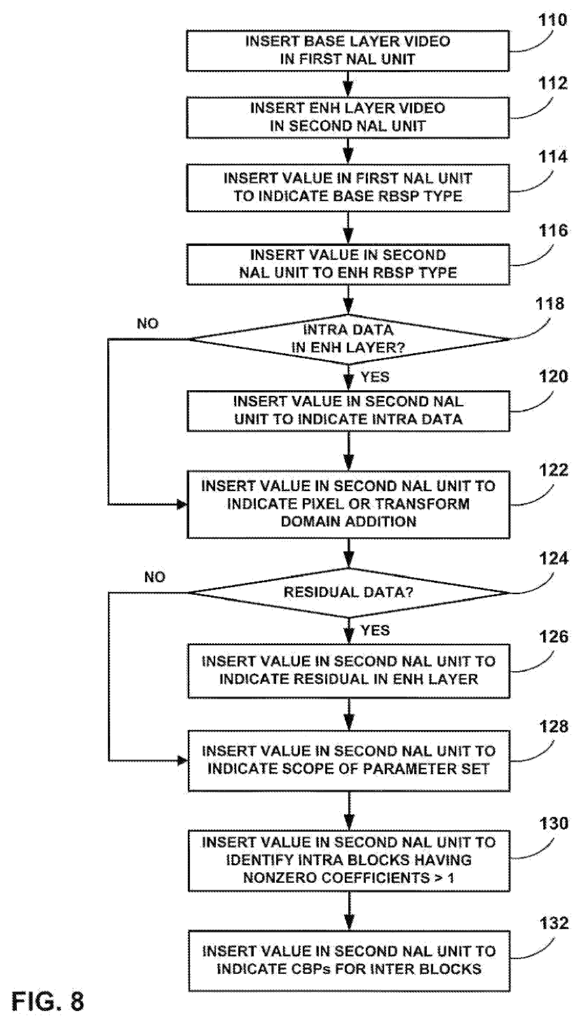

FIG. 8 is a flow diagram illustrating encoding of a scalable video bitstream to incorporate a variety of exemplary syntax elements to support low complexity video scalability. The various syntax elements may be inserted into NAL units carrying enhancement layer video data to identify the type of data carried in the NAL unit and communicate information to aid in decoding the enhancement layer video data. In general, the syntax elements, with associated semantics, may be generated by NAL unit module 23, and inserted in NAL units prior to transmission from broadcast server 12 to subscriber 16. As one example, NAL unit module 23 may set a NAL unit type parameter (e.g., nal_unit_type) in a NAL unit to a selected value (e.g., 30) to indicate that the NAL unit is an application specific NAL unit that may include enhancement layer video data. Other syntax elements and associated values, as described herein, may be generated by NAL unit module 23 to facilitate processing and decoding of enhancement layer video data carried in various NAL units. One or more syntax elements may be included in a first NAL unit including base layer video data, a second NAL unit including enhancement layer video data, or both to indicate the presence of the enhancement layer video data in the second NAL unit.

The syntax elements and semantics will be described in greater detail below. In FIG. 8, the process is illustrated with respect to transmission of both base layer video and enhancement layer video. In most cases, base layer video and enhancement layer video will both be transmitted. However, some subscriber devices 16 will receive only the NAL units carrying base layer video, due to distance from transmission tower 14, interference or other factors. From the perspective of broadcast server 12, however, base layer video and enhancement layer video are sent without regard to the inability of some subscriber devices 16 to receive both layers.

As shown in FIG. 8, encoded base layer video data and encoded enhancement layer video data from base layer encoder 32 and enhancement layer encoder 34, respectively, are received by NAL unit module 23 and inserted into respective NAL units as payload. In particular, NAL unit module 23 inserts encoded base layer video in a first NAL unit (110) and inserts encoded enhancement layer video in a second NAL unit (112). To aid video decoder 28, NAL unit module 23 inserts in the first NAL unit a value to indicate that the NAL unit type for the first NAL unit is an RBSP containing base layer video data (114). In addition, NAL unit module 23 inserts in the second NAL unit a value to indicate that the extended NAL unit type for the second NAL unit is an RBSP containing enhancement layer video data (116). The values may be associated with particular syntax elements. In this way, NAL unit module 27 in subscriber device 16 can distinguish NAL units containing base layer video data and enhancement layer video data, and detect when scalable video processing should be initiated by video decoder 28. The base layer bitstream may follow the exact H.264 format, whereas the enhancement layer bitstream may include an enhanced bitstream syntax element, e.g., “extended_nal_unit_type” in the NAL unit header. From the point of view of video decoder 28, the syntax element in a NAL unit header such as “extension flag” indicates an enhancement layer bitstream and triggers appropriate processing by the video decoder.

If the enhancement layer data includes intra-coded (I) data (118), NAL unit module 23 inserts a syntax element value in the second NAL unit to indicate the presence of intra data (120) in the enhancement layer data. In this manner, NAL unit module 27 can send information to video decoder 28 to indicate that Intra processing of the enhancement layer video data in the second NAL unit is necessary, assuming the second NAL unit is reliably received by subscriber device 16. In either case, whether the enhancement layer includes intra data or not (118), NAL unit module 23 also inserts a syntax element value in the second NAL unit to indicate whether addition of base layer video data and enhancement layer video data should be performed in the pixel domain or the transform domain (122), depending on the domain specified by enhancement layer encoder 34.

If residual data is present in the enhancement layer (124), NAL unit module 23 inserts a value in the second NAL unit to indicate the presence of residual information in the enhancement layer (126). In either case, whether residual data is present or no, NAL unit module 23 also inserts a value in the second NAL unit to indicate the scope of a parameter set carried in the second NAL unit (128). As further shown in FIG. 8, NAL unit module 23 also inserts a value in the second NAL unit, i.e., the NAL unit carrying the enhancement layer video data, to identify any intra-coded blocks, e.g., macroblocks (MBs), having nonzero coefficients greater than one (130).

In addition, NAL unit module 23 inserts a value in the second NAL unit to indicate the coded block patterns (CBPs) for inter-coded blocks in the enhancement layer video data carried by the second NAL unit (132). Identification of intra-coded blocks having nonzero coefficients in excess of one, and indication of the CBPs for the inter-coded block patterns aids the video decoder 28 in subscriber device 16 in performing scalable video decoding. In particular, NAL unit module 27 detects the various syntax elements and provides commands to entropy decoder 40 and combiner 38 to efficiently process base and enhancement layer video data for decoding purposes.

As an example, the presence of enhancement layer data in a NAL unit may be indicated by the syntax element “nal_unit_type,” which indicates an application specific NAL unit for which a particular decoding process is specified. A value of nal_unit_type in the unspecified range of H.264, e.g., a value of 30, can be used to indicate that the NAL unit is an application specific NAL unit. The syntax element “extension_flag” in the NAL unit header indicates that the application specific NAL unit includes extended NAL unit RBSP. Hence, the nal_unit_type and extension_flag may together indicate whether the NAL unit includes enhancement layer data. The syntax element “extended_nal_unit_type” indicates the particular type of enhancement layer data included in the NAL unit.

An indication of whether video decoder 28 should use pixel domain or transform domain addition may be indicated by the syntax element “decoding_mode_flag” in the enhancement slice header “enh_slice_header.” An indication of whether intra-coded data is present in the enhancement layer may be provided by the syntax element “refine_intra_mb_flag.” An indication of intra blocks having nonzero coefficients and intra CBP may be indicated by syntax elements such as “enh_intra16×16_macroblock_cbp( )” for intra 16×16 MBs in the enhancement layer macroblock layer (enh_macroblock_layer), and “coded_block_pattern” for intra4×4 mode in enh_macroblock_layer. Inter CBP may be indicated by the syntax element “enh_coded_block_pattern” in enh_macroblock_layer. The particular names of the syntax elements, although provided for purposes of illustration, may be subject to variation. Accordingly, the names should not be considered limiting of the functions and indications associated with such syntax elements.

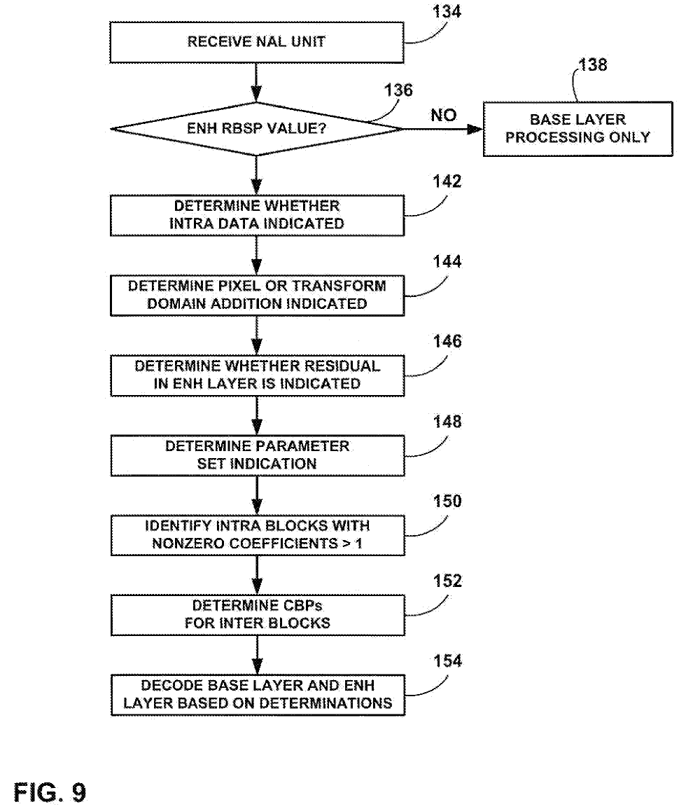

FIG. 9 is a flow diagram illustrating decoding of a scalable video bitstream to process a variety of exemplary syntax elements to support low complexity video scalability. The decoding process shown in FIG. 9 is generally reciprocal to the encoding process shown in FIG. 8 in the sense that it highlights processing of various syntax elements in a received enhancement layer NAL unit. As shown in FIG. 9, upon receipt of a NAL unit by receiver/demodulator 26 (134), NAL unit module 27 determines whether the NAL unit includes a syntax element value indicating that the NAL unit contains enhancement layer video data (136). If not, decoder 28 applies base layer video processing only (138). If the NAL unit type indicates enhancement layer data (136), however, NAL unit module 27 analyzes the NAL unit to detect other syntax elements associated with the enhancement layer video data. The additional syntax elements aid decoder 28 in providing efficient and orderly decoding of both the base layer and enhancement layer video data.

For example, NAL unit module 27 determines whether the enhancement layer video data in the NAL unit includes intra data (142), e.g., by detecting the presence of a pertinent syntax element value. In addition, NAL unit module 27 parses the NAL unit to detect syntax elements indicating whether pixel or transform domain addition of the base and enhancement layers is indicated (144), whether presence of residual data in the enhancement layer is indicated (146), and whether a parameter set is indicated and the scope of the parameter set (148). NAL unit module 27 also detects syntax elements identifying intra-coded blocks with nonzero coefficients greater than one (150) in the enhancement layer, and syntax elements indicating CBPs for the inter-coded blocks in the enhancement layer video data (152). Based on the determinations provided by the syntax elements, NAL unit module 27 provides appropriate indications to video decoder 28 for use in decoding the base layer and enhancement layer video data (154).

In the examples of FIGS. 8 and 9, enhancement layer NAL units may carry syntax elements with a variety of enhancement layer indications to aid a video decoder 28 in processing the NAL unit. As examples, the various indications may include an indication of whether the NAL unit includes intra-coded enhancement layer video data, an indication of whether a decoder should use pixel domain or transform domain addition of the enhancement layer video data with the base layer data, and/or an indication of whether the enhancement layer video data includes any residual data relative to the base layer video data. As further examples, the enhancement layer NAL units also may carry syntax elements indicating whether the NAL unit includes a sequence parameter, a picture parameter set, a slice of a reference picture or a slice data partition of a reference picture.

Other syntax elements may identify blocks within the enhancement layer video data containing non-zero transform coefficient values, indicate a number of nonzero coefficients in intra-coded blocks in the enhancement layer video data with a magnitude larger than one, and indicate coded block patterns for inter-coded blocks in the enhancement layer video data. Again, the examples provided in FIGS. 8 and 9 should not be considered limiting. Many additional syntax elements and semantics may be provided in enhancement layer NAL units, some of which will be discussed below.

Examples of enhancement layer syntax will now be described in greater detail with a discussion of applicable semantics. In some aspects, as described above, NAL units may be used in encoding and/or decoding of multimedia data, including base layer video data and enhancement layer video data. In such cases, the general syntax and structure of the enhancement layer NAL units may be the same as the H.264 standard. However, it should be apparent to those skilled in the art that other units may be used. Alternatively, it is possible to introduce new NAL unit type (nal_unit_type) values that specify the type of raw bit sequence payload (RBSP) data structure contained in an enhancement layer NAL unit.

In general, the enhancement layer syntax described in this disclosure may be characterized by low overhead semantics and low complexity, e.g., by single layer decoding. Enhancement macroblock layer syntax may be characterized by high compression efficiency, and may specify syntax elements for enhancement layer Intra_{—}16×16 coded block patterns (CBP), enhancement layer Inter MB CBP, and new entropy decoding using context adaptive variable length coding (CAVLC) coding tables for enhancement layer Intra MBs.

For low overhead, slice and MB syntax specifies association of an enhancement layer slice to a co-located base layer slice. Macroblock prediction modes and motion vectors can be conveyed in the base layer syntax. Enhancement MB modes can be derived from the co-located base layer MB modes. The enhancement layer MB coded block pattern (CBP) may be decoded in two different ways depending on the co-located base layer MB CBP.

For low complexity, single layer decoding may be accomplished by simply combining operations for base and enhancement layer bitstreams to reduce decoder complexity and power consumption. In this case, base layer coefficients may be converted to the enhancement layer scale, e.g., by multiplication with a scale factor, which may be accomplished by bit shifting based on the quantization parameter (QP) difference between the base and enhancement layer.

Also, for low complexity, a syntax element refine_intra_mb_flag may be provided to indicate the presence of an Intra MB in an enhancement layer P Slice. The default setting may be to set the value refine_intra_mb_flag==0 to enable single layer decoding. In this case, there is no refinement for Intra MBs at the enhancement layer. This will not adversely affect visual quality, even though the Intra MBs are coded at the base layer quality. In particular, intra MBs ordinarily correspond to newly appearing visual information and human eyes are not sensitive to it at the beginning. However, refine_intra_mb_flag=1 can still be provided for extension.

For high compression efficiency, enhancement layer Intra 16×16 MB CBP can be provided so that the partition of enhancement layer Intra 16×16 coefficients is defined based on base layer luma intra_{—}16×16 prediction modes. The enhancement layer intra_{—}16×16 MB cbp is decoded in two different ways depending on the co-located base layer MB cbp. In Case 1, in which the base layer AC coefficients are not all zero, the enhancement layer intra_{—}16×16 CBP is decoded according to H.264. A syntax element (e.g., BaseLayerAcCoefficentsAllZero) may be provided as a flag that indicates if all the AC coefficients of the corresponding macroblock in the base layer slice are zero. In Case 2, in which the base layer AC coefficients are all zero, a new approach may be provided to convey the intra_{—}16×16 cbp. In particular, the enhancement layer MB is partitioned into 4 sub-MB partitions depending on base layer luma intra_{—}16×16 prediction modes.

Enhancement layer Inter MB CBP may be provided to specify which of the six 8×8 blocks, luma and chroma, contain non-zero coefficients. The enhancement layer MB CBP is decoded in two different ways depending on the co-located base layer MB CBP. In Case 1, in which the co-located base layer MB CBP (base_coded_block_pattern or base_cbp) is zero, the enhancement layer MB CBP (enh_coded_block_pattern or enh_cbp) is decoded according to H.264. In case 2, in which base_coded_block_pattern is not equal to zero, a new approach to convey the enh_coded_block_pattern may be provided. For the base layer 8×8 with nonzero coefficients, one bit is used to indicate whether the co-located enhancement layer 8×8 has nonzero coefficients. The status of the other 8×8 blocks is represented by the variable length coding (VLC).

As a further refinement, new entropy decoding (CAVLC tables) can be provided for enhancement layer intra MBs to represent the number of non-zero coefficients in an enhancement layer Intra MB. The syntax element enh_coeff_token 0˜16 can represent the number of nonzero coefficients from 0 to 16 provided that there is no coefficient with magnitude larger than 1. The syntax element enh_coeff_token 17 represents that there is at least one nonzero coefficient with magnitude larger than 1. In this case (enh_coeff_token 17), a standard approach will be used to decode the total number of non-zero coefficients and the number of trailing one coefficients. The enh_coeff_token (0˜16) is decoded using one of the eight VLC tables based on context.

In this disclosure, various abbreviations are to be interpreted as specified in clause 4 of the H.264 standard. Conventions may be interpreted as specified in clause 5 of the H.264 standard and source, coded, decoded and output data formats, scanning processes, and neighboring relationships may be interpreted as specified in clause 6 of the H.264 standard.

Additionally, for the purposes of this specification, the following definitions may apply. The term base layer generally refers to a bitstream containing encoded video data which represents the first level of spatio-temporal-SNR scalability defined by this specification. A base layer bitstream is decodable by any compliant extended profile decoder of the H.264 standard. The syntax element BaseLayerAcCoefficentsAllZero is a variable which, when not equal to 0, indicates that all of the AC coefficients of a co-located macroblock in the base layer are zero.

The syntax element BaseLayerIntra16×16PredMode is a variable which indicates the prediction mode of the co-located Intra 16×16 prediction macroblock in the base layer. The syntax element BaseLayerIntra16×16PredMode has values 0, 1, 2, or 3 which correspond to Intra_{—}16×16_Vertical, Intra_{—}16×16_Horizontal, Intra_{—}16×16 _DC and Intra_{—}16×16_Planar, respectively. This variable is equal to the variable Intra16×16PredMode as specified in clause 8.3.3 of the H.264 standard. The syntax element BaseLayerMbType is a variable which indicates the macroblock type of a co-located macroblock in the base layer. This variable may be equal to the syntax element mb_type as specified in clause 7.3.5 of the H.264 standard.

The term base layer slice (or base_layer_slice) refers to a slice that is coded as per clause 7.3.3 the H.264 standard, which has a corresponding enhancement layer slice coded as specified in this disclosure with the same picture order count as defined in clause 8.2.1 of the H.264 standard. The element BaseLayerSliceType (or base_layer_slice_type) is a variable which indicates the slice type of the co-located slice in the base layer. This variable is equal to the syntax element slice_type as specified in clause 7.3.3 of the H.264 standard.

The term enhancement layer generally refers to a bitstream containing encoded video data which represents a second level of spatio-temporal-SNR scalability. The enhancement layer bitstream is only decodable in conjunction with the base layer, i.e., it contains references to the decoded base layer video data which are used to generate the final decoded video data.

A quarter-macroblock refers to one quarter of the samples of a macroblock which results from partitioning the macroblock. This definition is similar to the definition of a sub-macroblock in the H.264 standard except that quarter-macroblocks can take on non-square (e.g., rectangular) shapes. The term quarter-macroblock partition refers to a block of luma samples and two corresponding blocks of chroma samples resulting from a partitioning of a quarter-macroblock for inter prediction or intra refinement. This definition may be identical to the definition of sub-macroblock partition in the H.264 standard except that the term “intra refinement” is introduced by this specification.

The term macroblock partition refers to a block of luma samples and two corresponding blocks of chroma samples resulting from a partitioning of a macroblock for inter prediction or intra refinement. This definition is identical to that in the H.264 standard except that the term “intra refinement” is introduced in this disclosure. Also, the shapes of the macroblock partitions defined in this specification may be different than that of the H.264 standard.

### Enhancement Layer Syntax

RBSP Syntax

Table 1 below provides examples of RBSP types for low complexity video scalability.

TABLE 1
Raw byte sequence payloads and RBSP trailing bits

| RBSP | Description |
|---|---|
| Sequence parameter set RBSP | Sequence parameter set is only sent at the |
| | base layer |
| Picture parameter set RBSP | Picture parameter set is only sent at the |
| | base layer |
| Slice data partition RBSP | The enhancement layer slice data partition |
| syntax | RBSP syntax follows the H.264 standard. |

As indicated above, the syntax of the enhancement layer RBSP may be the same as the standard except that the sequence parameter set and picture parameter set may be sent at the base layer. For example, the sequence parameter set RBSP syntax, the picture parameter set RBSP syntax and the slice data partition RBSP coded in the enhancement layer may have a syntax as specified in clause 7 of the ITU-T H.264 standard.

In the various tables in this disclosure, all syntax elements may have the pertinent syntax and semantics indicated in the ITU-T H.264 standard, to the extent such syntax elements are described in the H.264 standard, unless specified otherwise. In general, syntax elements and semantics not described in the H.264 standard are described in this disclosure.

In various tables in this disclosure, the column marked “C” lists the categories of the syntax elements that may be present in the NAL unit, which may conform to categories in the H.264 standard. In addition, syntax elements with syntax category “All” may be present, as determined by the syntax and semantics of the RBSP data structure.

The presence or absence of any syntax elements of a particular listed category is determined from the syntax and semantics of the associated RBSP data structure. The descriptor column specifies a descriptor, e.g., f(n), u(n), b(n), ue(v), se(v), me(v), ce(v), that may generally conform to the descriptors specified in the H.264 standard, unless otherwise specified in this disclosure.

Extended NAL Unit Syntax

The syntax for NAL units for extensions for video scalability, in accordance with an aspect of this disclosure, may be generally specified as in Table 2 below.

TABLE 2
NAL Unit Syntax for Extensions

| nal_unit( NumBytesInNALunit ) { | C | Descriptor |
|---|---|---|
| forbidden_zero_bit | All | f(1) |
| nal_ref_idc | All | u(2) |
| nal_unit_type /* equal to 30 */ | All | u(5) |
| reserved_zero_1bit | All | u(1) |
| extension_flag | All | u(1) |
| if( !extension_flag ) { | | |
| enh_profile_idc | All | u(3) |
| reserved_zero_3bits | All | u(3) |
| } else | | |
| { | | |
| extended_nal_unit_type | All | u(6) |
| NumBytesInRBSP = 0 | | |
| for( i = 1; i < NumBytesInNALunit; i++ ) { | | |
| if( i + 2 < NumBytesInNALunit && | | |
| next_bits( 24 ) = = 0x000003 ) { | | |
| rbsp_byte[ NumBytesInRBSP++ ] | All | b(8) |
| rbsp_byte[ NumBytesInRBSP++ ] | All | b(8) |
| i += 2 | | |
| emulation_prevention_three_byte | | |
| /* equal to 0x03 */ | All | f(8) |
| } else | | |
| rbsp_byte[ NumBytesInRBSP++ ] | All | b(8) |
| } | | |
| } | | |
| } | | |

In the above Table 2, the value nal_unit_type is set to 30 to indicate a particular extension for enhancement layer processing. When the nal_unit_type is set to a selected value, e.g., 30, the NAL unit indicates that it carries enhancement layer data, triggering enhancement layer processing by decoder 28. The nal_unit_type value provides a unique, dedicated nal_unit_type to support processing of additional enhancement layer bitstream syntax modifications on top of a standard H.264 bitstream. As an example, this nal_unit_type value can be assigned a value of 30 to indicate that the NAL unit includes enhancement layer data, and trigger the processing of additional syntax elements that may be present in the NAL unit such as, e.g., extension_flag and extended_nal_unit_type. For example, the syntax element extended_nal_unit_type is set to a value to specify the type of extension. In particular, extended_nal_unit_type may indicate the enhancement layer NAL unit type. The element extended_nal_unit_type may indicate the type of RBSP data structure of the enhancement layer data in the NAL unit. For B slices, the slice header syntax may follow the H.264 standard. Applicable semantics will be described in greater detail throughout this disclosure.

Slice Header Syntax

For I slices and P slices at the enhancement layer, the slice header syntax can be defined as shown below in Table 3A below. Other parameters for the enhancement layer slice including reference frame information may be derived from the co-located base layer slice.

TABLE 3A
Slice Header Syntax

| enh_slice_header( ) { | C | Descriptor |
|---|---|---|
| first_mb_in_slice | 2 | ue(v) |
| enh_slice_type | 2 | ue(v) |
| pic_parameter_set_id | 2 | ue(v) |
| frame_num | 2 | u(v) |
| If( pic_order_cnt_type = = 0 ) { | | |
| pic_order_cnt_lsb | 2 | u(v) |
| if( pic_order_present_flag && !field_pic_flag) | | |
| delta_pic_order_cnt_bottom | 2 | ue(v) |
| } | | |
| If( pic_order_cnt_type = = 1 && | | |
| !delta_pic_order_always_zero_flag ) { | | |
| delta_pic_order_cnt[ 0 ] | 2 | se(v) |
| if( pic_order_present_flag && !field_pic_flag ) | | |
| delta_pic_order_cnt[ 1 ] | 2 | se(v) |
| } | | |
| if( redundant_pic_cnt_present_flag ) | | |
| redundant_pic_cnt | 2 | ue(v) |
| decoding_mode | 2 | ue(v) |
| if ( base_layer_slice_type != I) | | |
| refine_intra_MB | 2 | f(1) |
| slice_qp_delta | 2 | se(v) |
| } | | |

The element base_layer_slice may refer to a slice that is coded, e.g., per clause 7.3.3. of the H.264 standard, and which has a corresponding enhancement layer slice coded per Table 2 with the same picture order count as defined, e.g., in clause 8.2.1 of the H.264 standard. The element base_layer_slice_type refers to the slice type of the base layer, e.g., as specified in clause 7.3 of the H.264 standard. Other parameters for the enhancement layer slice including reference frame information are derived from the co-located base layer slice.

In the slice header syntax, refine_intra_MB indicates whether the enhancement layer video data in the NAL unit includes intra-coded video data. If refine_intra_MB is 0, intra coding exists only at the base layer. Accordingly, enhancement layer intra decoding can be skipped. If refine_intra_MB is 1, intra coded video data is present at both the base layer and the enhancement layer. In this case, the enhancement layer intra data can be processed to enhance the base layer intra data.

Slice Data Syntax

An example slice data syntax may be provided as specified in Table 3B below.

TABLE 3B
Slice Data Syntax

| | | |
|---|---|---|
| enh_slice_data( ) { | C | Descriptor |

```
  CurrMbAddr = first_mb_in_slice
  moreDataFlag = 1
  do {
    if( moreDataFlag ) {
      if ( BaseLayerMbType!=SKIP &&
      ( refine_intra_mb_flag ||
        (BaseLayerSliceType != I &&
        BaseLayerMbType!=I)) )
        enh_macroblock_layer( )
    }
    CurrMbAddr = NextMbAddress( CurrMbAddr )
    moreDataFlag = more_rbsp_data( )
  } while ( moreDataFlag )
}
```

Macroblock Layer Syntax

Example syntax for enhancement layer MBs may be provided as indicated in Table 4 below.

TABLE 4
Enhancement Layer MB Syntax

| enh_macroblock_layer( ) { | C | Descriptor |
|---|---|---|
| if ( MbPartPredMode( BaseLayerMbType, 0 ) == Intra_16x 16 ) { | | |
| enh_intra16x 16_macroblock_cbp( ) | | |
| if( mb_intra16x 16_luma_flag \|\| mb_intra16x 16_chroma_flag ) { | | |
| mb_qp_delta | 2 | se(v) |
| enh_residual( ) | 3\|4 | |
| } | | |
| } | | |
| else if ( MbPartPredMode( BaseLayerMbType, 0 ) == Intra_4x4 ) { | | |
| coded_block_pattern | 2 | me(v) |
| if (CodedBlockPatternLuma > 0 \|\| CodedBlockPatternChroma > 0) { | | |
| mb_qp_delta | | |
| enh_residual( ) | | |
| } | | |
| } | | |
| else { | | |
| enh_coded_block_pattern | 2 | me(v) |
| EnhCodedBlockPatternLuma = enh_coded_block_pattern % 16 | | |
| EnhCodedBlockPatternChroma = enh_coded_block_pattern /16 | | |
| if(EnhCodedBlockPatternLuma>0 \|\| EnhCodedBlockPatternChroma>0) | | |
| { | | |
| mb_qp_delta | 2 | se(v) |
| residual( ) | | |
| /* Standard compliant syntax as specified in clause 7.3.5.3 [1] */ | | |
| } | | |
| } | | |
| } | | |

### Other parameters for the enhancement macroblock layer are derived from the base layer macroblock layer for the corresponding macroblock in the corresponding base_layer_slice.

In Table 4 above, the syntax element enh_coded_block_pattern generally indicates whether the enhancement layer video data in an enhancement layer MB includes any residual data relative to the base layer data. Other parameters for the enhancement macroblock layer are derived from the base layer macroblock layer for the corresponding macroblock in the corresponding base_layer_slice.

Intra Macroblock Coded Block Pattern (CBP) Syntax

For intra4×4 MBs, CBP syntax can be the same as the H.264 standard, e.g. as in clause 7 of the H.264 standard. For intra16×16 MBs, new syntax to encode CBP information may be provided as indicated in Table 5 below.

TABLE 5
Intra 16x 16 Macroblocks CBP Syntax

| enh_intra16x 16_macroblock_cbp( ) { | C | Descriptor |
|---|---|---|
| mb_intra16x 16_luma_flag | 2 | u(1) |
| if( mb_intra16x 16_luma_flag ) { | | |
| if(BaseLayerAcCoefficientsAllZero) | | |
| for(mbPartIdx=0;mbPartIdx<4;mbPartIdx++) { | | |
| mb_intra16x 16_luma_part_flag[mbPartIdx] | 2 | u(1) |
| if( mb_intra16x 16_luma_part_flag[mbPartIdx] ) | | |
| for(qtrMbPartIdx=0;qtrMbPartIdx<4;qtrMbPartIdx++) | | |
| qtr_mb_intra16x 16_luma_part_flag | 2 | u(1) |
| [mbPartIdx][qtrMbPartIdx] | | |
| mb_intra16x 16_chroma_flag | 2 | u(1) |
| if( mb_intra16x 16_chroma_flag ) { | | |
| mb_intra16x 16_chroma_ac_flag | 2 | u(1) |
| } | | |

Residual Data Syntax

The syntax for intra-coded MB residuals in the enhancement layer, i.e., enhancement layer residual data syntax, may be as indicated in Table 6A below. For inter-coded MB residuals, the syntax may conform to the H.264 standard.

TABLE 6A
Intra-coded MB Residual Data Syntax

| enh_residual( ) { | C | Descriptor |
|---|---|---|
| if( MbPartPredMode( BaseLayerMbType, 0 ) = = Intra_16x 16 ) | | |
| enh_residual_block_cavlc( Intra16x 16DCLevel, 16 ) | 3 | |
| for( mbPartIdx = 0; mbPartIdx < 4; mbPartIdx++) | | |
| for( qtrMbPartIdx = 0; qtrMbPartIdx < 4; qtrMbPartIdx++ ) | | |
| if( MbPartPredMode( BaseLayerMbType, 0 ) = = Intra_16x 16 && | | |
| BaseLayerAcCoefficientsAllZero ) { | | |
| if( mb_intra16x 16_luma_part_flag[mbPartIdx] && | | |
| qtr_mb_intra16x 16_luma_part_flag[mbPartIdx][qtrMbPartIdx] | | |
| ) | | |
| enh_residual_block_cavlc(Intra16x 16ACLevel[ mbPartIdx * 4 + qtrMbPartId | 3 | |
| x ], 15 ) | | |
| else | | |
| for( i = 0; i < 15; i++) | | |
| Intra16x 16ACLevel[ mbPartIdx * 4 + qtrMbPartIdx ][ i ] = 0 | | |
| else if( EnhCodedBlockPatternLuma & (1 << mbPartIdx)) { | | |
| if( MbPartPredMode( BaseLayerMbType, 0 ) = = Intra_16x 16 ) | | |
| enh_residual_block_cavlc( | 3 | |
| Intra16x 16ACLevel[ mbPartIdx * 4 + qtrMbPartIdx ], 15 ) | | |
| else | | |
| enh_residual_block_cavlc( | 3\|4 | |
| LumaLevel[ mbPartIdx * 4 + qtrMbPartIdx ], 16 ) | | |
| } else { | | |
| if( MbPartPredMode( BaseLayerMbType, 0 ) = = Intra_16x 16 ) | | |
| for( i = 0; i < 15; i++ ) | | |
| Intra16x 16ACLevel[ mbPartIdx * 4 + qtrMbPartIdx ][ i ] = 0 | | |
| else | | |
| for( i = 0; i < 16; i++ ) | | |
| LumaLevel[ mbPartIdx * 4 + qtrMbPartIdx ][ i ] = 0 | | |
| } | | |
| for( iCbCr = 0; iCbCr < 2; iCbCr++ ) | | |
| if( EnhCodedBlockPatternChroma & 3 ) /* chroma DC residual present | | |
| */ | | |
| residual_block( ChromaDCLevel[ iCbCr ], 4 ) | 3\|4 | |
| else | | |
| for( i = 0; i < 4; i++ ) | | |
| ChromaDCLevel[ iCbCr ][ i ] = 0 | | |
| for( iCbCr = 0; iCbCr < 2; iCbCr++ ) | | |
| for( qtrMbPartIdx = 0; qtrMbPartIdx < 4; qtrMbPartIdx++ ) | | |
| if( EnhCodedBlockPatternChroma & 2 ) | | |
| /* chroma AC residual present */ | | |
| residual_block( ChromaACLevel[ iCbCr ][ qtrMbPartIdx ], 15 ) | 3\|4 | |
| else | | |
| for( i = 0; i < 15; i++ ) | | |
| ChromaACLevel[ iCbCr ][ qtrMbPartIdx ][ i ] = 0 | | |
| } | | |

### Other parameters for the enhancement layer residual are derived from the base layer residual for the co-located macroblock in the corresponding base layer slice.

Residual Block CAVLC Syntax

The syntax for enhancement layer residual block context adaptive variable length coding (CAVLC) may be as specified in Table 6B below.

TABLE 6B
Residual Block CAVLC Syntax

| enh_residual_block_cavlc( coeffLevel, maxNumCoeff ) { | C | Descriptor |
|---|---|---|
| for( i = 0; i < maxNumCoeff; i++ ) | | |
| coeffLevel[ i ] = 0 | | |
| if( (MbPartPredMode( BaseLayerMbType, 0 ) == Intra_16x 16 && | | |
| mb_intra16x 16_luma_flag) \|\| (MbPartPredMode( BaseLayerMbType, 0 ) == | | |
| Intra_4x4 && CodedBlockPatternLuma) { | | |
| enh_coeff_token | 3\|4 | ce(v) |
| if( enh_coeff_token == 17) { | | |
| /* Standard compliant syntax as specified in clause 7.3.5.3.1 of H.264 */ | | |
| } | | |
| else { | | |
| if( TotalCoeff( enh_coeff_token) > 0) { | | |
| for(i = 0; i < TotalCoeff( enh_coeff_token ); i++ ) | | |
| enh_coeff_sign_flag[ i ] | 3\|4 | u(1) |
| level[ i ] = 1 − 2 * enh_coeff_sign_flag | | |
| if( TotalCoeff( enh_coeff_token ) < maxNumCoeff) { | | |
| total_zeros | 3\|4 | ce(v) |
| zerosLeft = total_zeros | | |
| } else | | |
| zerosLeft = 0 | | |
| for( i=0; i < Totalcoeff( enh_coeff_token ) − 1; i++ ) { | | |
| if( zerosLeft > 0) { | | |
| run_before | 3\|4 | ce(v) |
| run[ i ] = run_before | | |
| } else | | |
| run[ i ] = 0 | | |
| zerosLeft = zerosLeft − run[ i ] | | |
| } | | |
| run[ TotalCoeff( enh_coeff_token ) − 1 ] = zerosLeft | | |
| coeffNum = −1 | | |
| for( i = TotalCoeff( enh_coeff_token) − 1; i >= 0; i−−) { | | |
| coeffNum += run[ i ] + 1 | | |
| coeffLevel[ coeffNum ] = level[ i ] | | |
| } | | |
| } | | |
| } else { | | |
| /* Standard compliant syntax as specified in clause 7.3.5.3.1 of H.264 */ | | |
| } | | |
| } | | |

### Other parameters for the enhancement layer residual block CAVLC can be derived from the base layer residual block CAVLC for the co-located macroblock in the corresponding base layer slice.

### Enhancement Layer Semantics

Enhancement layer semantics will now be described. The semantics of the enhancement layer NAL units may be substantially the same as the syntax of NAL units specified by the H.264 standard for syntax elements specified in the H.264 standard. New syntax elements not described in the H.264 standard have the applicable semantics described in this disclosure. The semantics of the enhancement layer RBSP and RBSP trailing bits may be the same as the H.264 standard.

Extended NAL Unit Semantics

With reference to Table 2 above, forbidden_zero_bit is as specified in clause 7 of the H.264 standard specification. The value nal_ref_idc not equal to 0 specifies that the content of an extended NAL unit contains a sequence parameter set or a picture parameter set or a slice of a reference picture or a slice data partition of a reference picture. The value nal_ref_idc equal to 0 for an extended NAL unit containing a slice or slice data partition indicates that the slice or slice data partition is part of a non-reference picture. The value of nal_ref_idc shall not be equal to 0 for sequence parameter set or picture parameter set NAL units.

When nal_ref_idc is equal to 0 for one slice or slice data partition extended NAL unit of a particular picture, it shall be equal to 0 for all slice and slice data partition extended NAL units of the picture. The value nal_ref_idc shall not be equal to 0 for IDR Extended NAL units, i.e., NAL units with extended nal_unit_type equal to 5, as indicated in Table 7 below. In addition, nal_ref_idc shall be equal to 0 for all Extended NAL units having extended_nal_unit_type equal to 6, 9, 10, 11, or 12, as indicated in Table 7 below.

The value nal_unit_type has a value of 30 in the “Unspecified” range of H.264 to indicate an application specific NAL unit, the decoding process for which is specified in this disclosure. The value nal_unit_type not equal to 30 is as specified in clause 7 of the H.264 standard.

The value extension_flag is a one-bit flag. When extension_flag is 0, it specifies that the following 6 bits are reserved. When extension_flag is 1, it specifies that this NAL unit contains extended NAL unit RBSP.

The value reserved or reserved_zero_{—}1bit is a one-bit flag to be used for future extensions to applications corresponding to nal_unit_type of 30. The value enh_profile_idc indicates the profile to which the bitstream conforms. The value reserved_zero_{—}3bits is a 3 bit field reserved for future use.

The value extended_nal_unit_type is as specified in Table 7 below:

TABLE 7
Extended NAL unit type codes

| | Content of Extended NAL unit and RBSP syntax | |
|---|---|---|
| extended_nal_unit type | structure | C |
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 . . . 23 | Reserved | |
| 24 . . . 63 | Unspecified | |

Extended NAL units that use extended_nal_unit_type equal to 0 or in the range of 24 . . . 63, inclusive, do not affect the decoding process described in this disclosure. Extended NAL unit types 0 and 24 . . . 63 may be used as determined by the application. No decoding process for these values (0 and 24 . . . 63) of nal_unit_type is specified. In this example, decoders may ignore, i.e., remove from the bitstream and discard, the contents of all Extended NAL units that use reserved values of extended_nal_unit_type. This potential requirement allows future definition of compatible extensions. The values rbsp_byte and emulation_prevention_three_byte are as specified in clause 7 of the H.264 standard specification.

RBSP Semantics

The semantics of the enhancement layer RBSPs are as specified in clause 7 of the H.264 standard specification.

Slice Header Semantics

For slice header semantics, the syntax element first_mb_in_slice specifies the address of the first macroblock in the slice. When arbitrary slice order is not allowed, the value of first_mb_in_slice is not to be less than the value of first_mb_in_slice for any other slice of the current picture that precedes the current slice in decoding order. The first macroblock address of the slice may be derived as follows. The value first_mb_in_slice is the macroblock address of the first macroblock in the slice, and first_mb_in_slice is in the range of 0 to PicSizeInMbs-1, inclusive, where PicSizeInMbs is the number of megabytes in a picture.

The element enh_slice_type specifies the coding type of the slice according to Table 8 below.

TABLE 8
Name association to values of enh_slice_type

| enh_slice_type | Name of enh_slice_type |
|---|---|
| 0 | P (P slice) |
| 1 | B (B slice) |
| 2 | I (I slice) |
| 3 | SP (SP slice) or Unused |
| 4 | SI (SI slice) or Unused |
| 5 | P (P slice) |
| 6 | B (B slice) |
| 7 | I (I slice) |
| 8 | SP (SP slice) or Unused |
| 9 | SI (SI slice) or Unused |

Values of enh_slice_type in the range of 5 to 9 specify, in addition to the coding type of the current slice, that all other slices of the current coded picture have a value of enh_slice_type equal to the current value of enh_slice_type or equal to the current value of slice_type-5. In alternative aspects, enh_slice_type values 3, 4, 8 and 9 may be unused. When extended_nal_uni_type is equal to 5, corresponding to an instantaneous decoding refresh (IDR) picture, slice_type can be equal to 2, 4, 7, or 9.

The syntax element pic_parameter_set_id is specified as the pic_parameter_set_id of the corresponding base_layer_slice. The element frame_num in the enhancement layer NAL unit will be the same as the base layer co-located slice. Similarly, the element pic_order_cnt_{—}1sb in the enhancement layer NAL unit will be the same as the pic_order_cnt_{—}1sb for the base layer co-located slice (base_layer_slice). The semantics for delta_pic_order_cnt_bottom, delta_pic_order_cnt[0], delta_pic_order cnt[1], and redundant_pic_cnt semantics are as specified in clause 7.3.3 of the H.264 standard. The element decoding_mode_flag specifies the decoding process for the enhancement layer slice as shown in Table 9 below.

TABLE 9
Specification of decoding_mode_flag

| decoding_mode_flag | process |
|---|---|
| 0 | Pixel domain addition |
| 1 | Coefficient domain addition |

In Table 9 above, pixel domain addition, indicated by a decoding_mode_flag value of 0 in the NAL unit, means that the enhancement layer slice is to be added to the base layer slice in the pixel domain to support single layer decoding. Coefficient domain addition, indicated by a decoding_mode_flag value of 1 in the NAL unit, means that the enhancement layer slice can be added to the base layer slice in the coefficient domain to support single layer decoding. Hence, decoding_mode_flag provides a syntax element that indicates whether a decoder should use pixel domain or transform domain addition of the enhancement layer video data with the base layer data.

Pixel domain addition results in the enhancement layer slice being added to the base layer slice in the pixel domain as follows:

Y[i][j]=Clip1_{Y}(Y[i][j]_{base}+Y[i][j]ₑₙₕ)

Cb[i][j]=Clip1_{C}(Cb[i][b]_{base}+Cb[i][b]ₑₙₕ)

Cr[i][j]=Clip1_{C}(Cr[i][j]_{base}+Cr[i][j]ₑₙₕ)

where Y indicates luminance, Cb indicates blue chrominance and Cr indicates red chrominance, and where Clip1Y is a mathematical function as follows:

Clip1_{y}(x)=Clip3(0,(1<<BitDepth_{Y})−1, x)

and Clip1_{C} is a mathematical function as follows:

Clip1_{C}(x)=Clip3(0,(1<<BitDepth_{c})−1, x),

and where Clip3 is described elsewhere in this document. The mathematical functions Clip1y, Clip1c and Clip3 are defined in the H.264 standard.

Coefficient domain addition results in the enhancement layer slice being added to the base layer slice in the coefficient domain as follows:

LumaLevel[i][j]=k LumaLevel[i][j]_{base}+LumaLevel[i][j]ₑₙₕ

ChromaLevel[i][j]=kChromaLevel[i][j]_{base}+ChromaLevel[i][j]ₑₙₕ

where k is a scaling factor used to adjust the base layer coefficients to the enhancement layer QP scale.

The syntax element refine_intra_MB in the enhancement layer NAL unit specifies whether to refine intra MBs at the enhancement layer in non-I slices. If refine_intra_MB is equal to 0, intra MBs are not refined at the enhancement layer and those MBs will be skipped in the enhancement layer. If refine_intra_MB is equal to 1, intra MBs are refined at the enhancement layer.

The element slice_qp_delta specifies the initial value of the luma quantization parameter QP_{Y} to be used for all the macroblocks in the slice until modified by the value of mb_qp_delta in the macroblock layer. The initial QP_{Y} quantization parameter for the slice is computed as:

SliceQP_{Y}=26+pic_init_{—}qp_minus26+slice_{—}qp_delta

The value of slice_qp_delta may be limited such that QP_{Y} is in the range of 0 to 51, inclusive. The value pic_init_qp_minus26 indicates the initial QP value.

Slice Data Semantics

The semantics of the enhancement layer slice data may be as specified in clause 7.4.4 of the H.264 standard.

Macroblock Layer Semantics

With respect to macroblock layer semantics, the element enh_coded_block_pattern specifies which of the six 8×8 blocks—luma and chroma—may contain non-zero transform coefficient levels. The element mb_qp_delta semantics may be as specified in clause 7.4.5 of the H.264 standard. The semantics for syntax element coded_block_pattern may be as specified in clause 7.4.5 of the H.264 standard.

Intra 16×16 Macroblock Coded Block Pattern (CBP) Semantics

For I slices and P slices when refine_intra_mb_flag is equal to 1, the following description defines Intra 16×16 CBP semantics. Macroblocks that have their co-located base layer macroblock prediction mode equal to Intra_{—}16×16 can be partitioned into 4 quarter-macroblocks depending on the values of their AC coefficients and the intra_{—}16×16 prediction mode of the co-located base layer macroblock (BaseLayerIntra16×16PredMode). If the base layer AC coefficients are all zero and at least one enhancement layer AC coefficient is non-zero, the enhancement layer macroblock is divided into 4 macroblock partitions depending on BaseLayerIntra16×16PredMode.

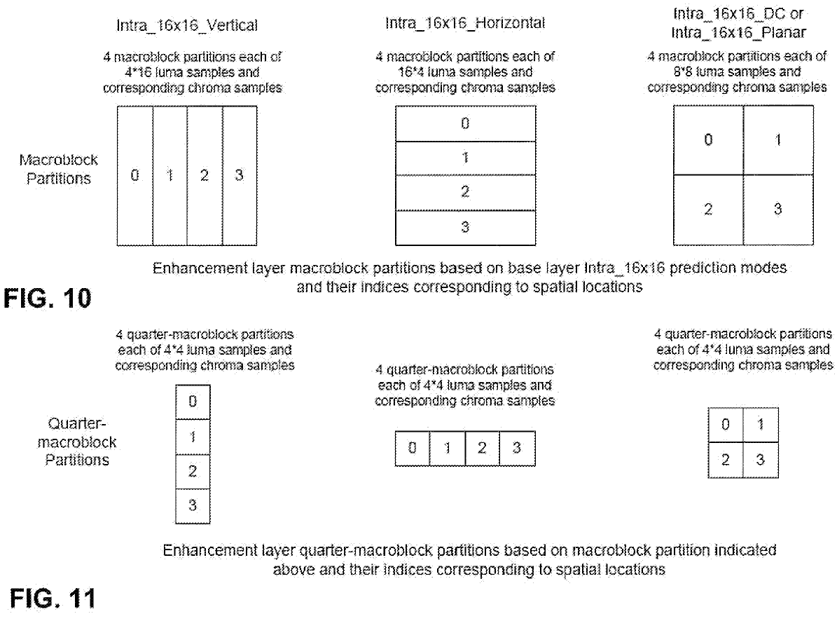

The macroblock partitioning results in partitions called quarter-macroblocks. Each quarter-macroblock can be further partitioned into 4×4 quarter-macroblock partitions. FIGS. 10 and 11 are diagrams illustrating the partitioning of macroblocks and quarter-macroblocks. FIG. 10 shows enhancement layer macroblock partitions based on base layer intra_{—}16×16 prediction modes and their indices corresponding to spatial locations. FIG. 11 shows enhancement layer quarter-macroblock partitions based on macroblock partitions indicated in FIG. 10 and their indices corresponding to spatial locations.

FIG. 10 shows an Intra_{—}16×16_Vertical mode with 4 MB partitions each of 4*16 luma samples and corresponding chroma samples, an Intra_{—}16×16_Horizontal mode with 4 macroblock partitions each of 16*4 luma samples and corresponding chroma samples, and an Intra_{—}16×16_DC or Intra_{—}16×16_Planar mode with 4 macroblock partitions each of 8*8 luma samples and corresponding chroma samples.

FIG. 11 shows 4 quarter macroblock vertical partitions each of 4*4 luma samples and corresponding chroma samples, 4 quarter macroblock horizontal partitions each of 4*4 luma samples and corresponding chroma samples, and 4 quarter macroblock DC or planar partitions each of 4*4 luma samples and corresponding chroma samples.

Each macroblock partition is referred to by mbPartIdx. Each quarter-macroblock partition is referred to by qtrMbPartIdx. Both mbPartIdx and qtrMbPartIdx can have values equal to 0, 1, 2, or 3. Macroblock and quarter-macroblock partitions are scanned for intra refinement as shown in FIGS. 10 and 11. The rectangles refer to the partitions. The number in each rectangle specifies the index of the macroblock partition scan or quarter-macroblock partition scan.

The element mb_intra16×16_luma flag equal to 1 specifies that at least one coefficient in Intra16×16ACLevel is non-zero. Intra16×16_luma_flag equal to 0 specifies that all coefficients in Intra16×16ACLevel are zero.

The element mb_intra16×16_luma_part_flag[mbPartIdx] equal to 1 specifies that there is at least one nonzero coefficient in Intra16×16ACLevel in the macroblock partition mbPartIdx. mb_intra16×16_luma_part_flag[mbPartIdx] equal to 0 specifies that all coefficients in Intra16×16ACLevel in the macroblock partition mbPartIdx are zero.

The element qtr_mb_intra16×16_luma_part_flag[mbPartIdx][qtrMbPartIdx] equal to 1 specifies that there is at least one nonzero coefficient in Intra16×16ACLevel in the quarter-macroblock partition qtrMbPartIdx.

The element qtr_mb_intra16×16_luma_part_flag[mbPartIdx][[qtrMbPartIdx equal to 0 specifies that all coefficients in Intra16×16ACLevel in the quarter-macroblock partition qtrMbPartIdx are zero. The element mb_intra16×16_chroma_flag equal to 1 specifies that at least one chroma coefficient is non zero.

The element mb_intra16×16_chroma_flag equal to 0 specifies that all chroma coefficients are zero. The element mb_intra16×16_chroma_AC_flag equal to 1 specifies that at least one Chroma coefficient in mb_ChromaACLevel is non zero. mb_intra16×16_chroma_AC_flag equal to 0 specifies that all coefficients in mb_ChromaACLevel are zero.

Residual Data Semantics

The semantics of residual data, with the exception of residual block CAVLC semantics described in this disclosure, may be the same as specified in clause 7.4.5.3 of the H.264 standard.

Residual Block CAVLC Semantics

Residual block CAVLC semantics may be provided as follows. In particular, enh_coeff_token specifies the total number of non-zero transform coefficient levels in a transform coefficient level scan. The function TotalCeoff(enh_coeff_token) returns the number of non-zero transform coefficient levels derived from enh_coeff_token as follows:

1. When enh_coeff_token is equal to 17, TotalCoeff(enh_coeff_token) is as specified in clause 7.4.5.3.1 of the H.264 standard.

2. When enh_coeff_token is not equal to 17, TotalCoeff(enh_coeff_token) is equal to enh_coeff_token.

The value enh_coeff_sign flag specifies the sign of a non-zero transform coefficient level. The total_zeros semantics are as specified in clause 7.4.5.3.1 of the H.264 standard. The run_before semantics are as specified in clause 7.4.5.3.1 of the H.264 standard.

### Decoding Processes for Extensions

I Slice Decoding

Decoding processes for scalability extensions will now be described in more detail. To decode an I frame when data from both the base layer and enhancement layer are available, a two pass decoding may be implemented in decoder 28. The two pass decoding process may generally work as previously described, and as reiterated as follows. First, a base layer frame I_{b} is reconstructed as a usual I frame. Then, the co-located enhancement layer I frame is reconstructed as a P frame. The reference frame for this P frame is then the reconstructed base layer I frame. Again, all the motion vectors in the reconstructed enhancement layer P frame are zero.

When the enhancement layer is available, each enhancement layer macroblock is decoded as residual data using the mode information from the co-located macroblock in the base layer. The base layer I slice, I_{b}, may be decoded as in clause 8 of the H.264 standard. After both the enhancement layer macroblock and its co-located base layer macroblock have been decoded, a pixel domain addition as specified in clause 2.1.2.3 of the H.264 standard may be applied to produce the final reconstructed block.

### P Slice Decoding

In the decoding process for P slices, both the base layer and the enhancement layer share the same mode and motion information, which is transmitted in the base layer. The information for inter macroblocks exist in both layers. In other words, the bits belonging to intra MBs only exist at the base layer, with no intra MB bits at the enhancement layer, while coefficients of inter MBs scatter across both layers. Enhancement layer macroblocks that have co-located base layer skipped macroblocks are also skipped.

If refine_intra_mb_flag is equal to 1, the information belonging to intra macroblocks exist in both layers, and decoding_mode_flag has to be equal to 0. Otherwise, when refine_intra_mb_flag is equal to 0, the information belonging to intra macroblocks exist only in the base layer, and enhancement layer macroblocks that have co-located base layer intra macroblocks are skipped.

According to one aspect of a P slice encoding design, the two layer coefficient data of inter MBs can be combined in a general purpose microprocessor, immediately after entropy decoding and before dequantization, because the dequantization module is located in the hardware core and it is pipelined with other modules. Consequently, the total number of MBs to be processed by the DSP and hardware core still may be the same as the single layer decoding case and the hardware core only goes through a single decoding. In this case, there may be no need to change hardware core scheduling.

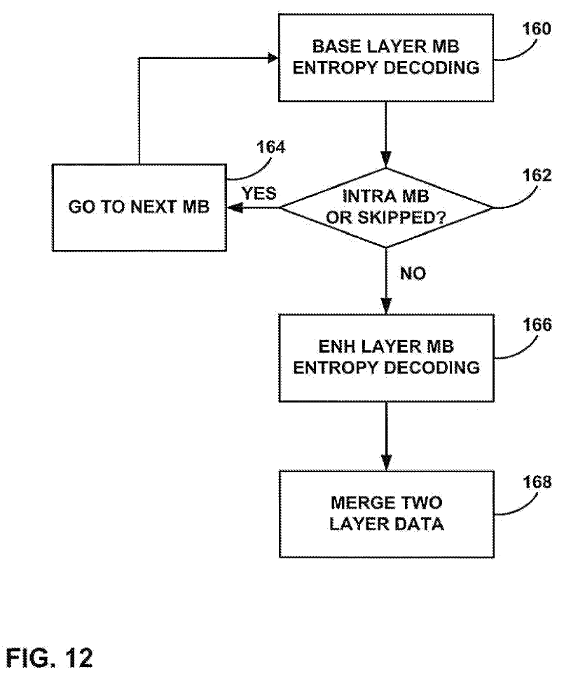

FIG. 12 is a flow diagram illustrating P slice decoding. As shown in FIG. 12, video decoder 28 performs base layer MB entropy decoding (160). If the current base layer MB is an intra-coded MB or is skipped (162), video decoder 28 proceeds to the next base layer MB 164. If the MB is not intra-coded or skipped, however, video decoder 28 performs entropy decoding for the co-located enhancement layer MB (166), and then merges the two layers of data (168), i.e., the entropy decoded base layer MB and the co-located entropy decoded enhancement layer MB, to produce a single layer of data for inverse quantization and inverse transform operations. The tasks shown in FIG. 12 can be performed within a general purpose microprocessor before handing the single, merged layer of data to the hardware core for inverse quantization and inverse transformation. Based on the procedure shown in FIG. 12, the management of a decoded picture buffer (dpb) is the same or nearly the same as single layer decoding, and no extra memory may be needed.

Enhancement Layer Intra Macroblock Decoding

For enhancement layer intra macroblock decoding, during entropy decoding of transform coefficients, CAVLC may require context information which is handled differently in base layer decoding and enhancement layer decoding. The context information includes the number of non-zero transform coefficient levels (given by TotalCoeff(coeff_token)) in the block of transform coefficient levels located to the left of the current block (blkA) and the block of transform coefficient levels located above the current block (blkB).

For entropy decoding of enhancement layer intra macroblocks with non-zero coefficient base layer co-located macroblock, the context for decoding coeff token is the number of nonzero coefficients in the co-located base layer blocks. For entropy decoding of enhancement layer intra macroblocks with all-zero coefficients base layer co-located macroblock, the context for decoding coeff token is the enhancement layer context, and nA and nB are the number of non-zero transform coefficient levels (given by TotalCoeff(coeff_token)) in the enhancement layer block blkA located to the left of the current block and the base layer block blkB located above the current block, respectively.

After entropy decoding, information is saved by decoder 28 for entropy decoding of other macroblocks and deblocking. For only base layer decoding with no enhancement layer decoding, the TotalCoeff(coeff_token) of each transform block is saved. This information is used as context for the entropy decoding of other macroblocks and to control deblocking. For enhancement layer video decoding, TotalCoeff(enh_coeff_token) is used as context and to control deblocking.

In one aspect, a hardware core in decoder 28 is configured to handle entropy decoding. In this aspect, a DSP may be configured to inform the hardware core to decode the P frame with zero motion vectors. To the hardware core, a conventional P frame is being decoded and the scalable decoding is transparent. Again, compared to single layer decoding, decoding an enhancement layer I frame is generally equivalent to the decoding time of a conventional I frame and P frame.

If the frequency of I frames is not larger than one frame per second, the extra complexity is not significant. If the frequency is more than one I frame per second (because of scene change or some other reason), the encoding algorithm can make sure that those designated I frames are only encoded at the base layer.

Derivation Process for enh_coeff_token

A derivation process for enh_coeff_token will now be described. The syntax element_enh_coeff_token may be decoded using one of the eight VLCs specified in Tables 10 and 11 below. The element enh_coeff_sign flag specifies the sign of a non-zero transform coefficient level. The VLCs in Tables 10 and 11 are based on statistical information over 27 MPEG2 decoded sequences. Each VLC specifies the value TotalCoeff(enh_coeff_token) for a given codeword enh_coeff_token. VLC selection is dependent upon a variable numcoeff_vlc that is derived as follows. If the base layer collocated block has nonzero coefficients, the following applies:

if (base_nC<2)
numcoeff_vlc=0;

else if (base_nC<4)
numcoeff_vlc=1;

else if (base_nC<8)
numcoeff_vlc=2;

Else
numcoeff₁₃ vlc=3;
   Otherwise, nC is found using the H.264 standard compliant technique and numcoeff_vlc is derived as follows:

if (nC<2)
numcoeff_vlc=4;

Else if (nC<4)
numcoeff_vlc=5;

Else if (nC<8)
numcoeff_vlc=6;

Else
numcoeff_vlc=7;

TABLE 10
Codetables for decoding enh_coeff_token, numcoeff_vlc = 0–3

| enh_coeff_token | numcoeff_vlc = 0 | numcoeff_vlc = 1 | numcoeff_vlc = 2 | numcoeff_vlc = 3 |
|---|---|---|---|---|
| 0 | 10 | 101 | 1111 0 | 1001 1 |
| 1 | 11 | 01 | 101 | 1111 |
| 2 | 00 | 00 | 00 | 110 |
| 3 | 010 | 111 | 01 | 01 |
| 4 | 0110 | 100 | 110 | 00 |
| 5 | 0111 0 | 1100 | 100 | 101 |
| 6 | 0111 101 | 1101 0 | 1110 | 1110 |
| 7 | 0111 1001 | 1101 101 | 1111 10 | 1001 0 |
| 8 | 0111 1000 1 | 1101 1001 | 1111 1111 | 1000 11 |
| 9 | 0111 1000 01 | 1101 1000 1 | 1111 1110 1 | 1000 101 |
| 10 | 0111 1000 001 | 1101 1000 01 | 1111 1110 01 | 1000 1000 |
| 11 | 0111 1000 0001 1 | 1101 1000 001 | 1111 1110 001 | 1000 1001 00 |
| 12 | 0111 1000 0001 0 | 1101 1000 0001 | 1111 1110 0001 | 1000 1001 01 |
| 13 | 0111 1000 0000 0 | 1101 1000 0000 | 1111 1110 0000 | 1000 1001 100 |
| | | 11 | 00 | |
| 14 | 0111 1000 0000 | 1101 1000 0000 | 1111 1110 0000 | 1000 1001 101 |
| | 10 | 00 | 01 | |
| 15 | 0111 1000 0000 | 1101 1000 0000 | 1111 1110 0000 | 1000 1001 110 |
| | 110 | 01 | 10 | |
| 16 | 0111 1000 0000 | 1101 1000 0000 | 1111 1110 0000 | 1000 1001 111 |
| | 111 | 10 | 11 | |
| 17 | 0111 11 | 1101 11 | 1111 110 | 1000 0 |

TABLE 11
Codetables for decoding enh_coeff_token, numcoeff_vlc = 4–7

| enh_coeff_token | numcoeff_vlc = 4 | numcoeff_vlc = 5 | numcoeff_vlc = 6 | numcoeff_vlc = 7 |
|---|---|---|---|---|
| 0 | 1 | 11 | 10 | 1010 |
| 1 | 01 | 10 | 01 | 1011 |
| 2 | 001 | 01 | 00 | 100 |
| 3 | 0001 | 001 | 110 | 1100 |
| 4 | 0000 1 | 0001 | 1110 | 0000 |
| 5 | 0000 00 | 0000 1 | 1111 0 | 0001 |
| 6 | 0000 0101 | 0000 01 | 1111 10 | 0010 |
| 7 | 0000 0100 1 | 0000 000 | 1111 110 | 0011 |
| 8 | 0000 0100 01 | 0000 0011 1 | 1111 1110 1 | 0100 |
| 9 | 0000 0100 001 | 0000 0011 01 | 1111 1110 01 | 0101 |
| 10 | 0000 0100 0000 | 0000 0011 000 | 1111 1110 0011 | 0110 |
| 11 | 0000 0100 0001 | 0000 0011 001 00 | 1111 1110 0000 0 | 0111 |
| | 11 | | | |
| 12 | 0000 0100 0001 | 0000 0011 001 01 | 1111 1110 0000 1 | 1101 0 |
| | 00 | | | |
| 13 | 0000 0100 0001 | 0000 0011 0011 | 1111 1110 0001 0 | 1101 1 |
| | 010 | 00 | | |
| 14 | 0000 0100 0001 | 0000 0011 0011 | 1111 1110 0001 1 | 1110 0 |
| | 011 | 01 | | |
| 15 | 0000 0100 0001 | 0000 0011 0011 | 1111 1110 0010 0 | 1110 1 |
| | 100 | 10 | | |
| 16 | 0000 0100 0001 | 0000 0011 0011 | 1111 1110 0010 1 | 1111 0 |
| | 101 | 11 | | |
| 17 | 0000 011 | 0000 0010 | 1111 1111 | 1111 1 |

Enhancement Layer Inter Macroblock Decoding

Enhancement layer inter macroblock decoding will now be described. For inter macroblocks (except skipped macroblocks), decoder 28 decodes the residual information from both the base and enhancement layers. Consequently, decoder 28 may be configured to provide two entropy decoding processes that may be required for each macroblock.

If both the base and enhancement layers have non-zero coefficients for a macroblock, context information of neighboring macroblocks is used in both layers to decode coeff_token. Each layer uses different context information.

After entropy decoding, information is saved as context information for entropy decoding of other macroblocks and deblocking. For base layer decoding the decoded TotalCoeff(coeff_token) is saved. For enhancement layer decoding, the base layer decoded TotalCoeff(coeff_token) and the enhancement layer TotalCoeff(enh_coeff_token) are saved separately. The parameter TotalCoeff(coeff_token) is used as context to decode the base layer macroblock coeff_token including intra macroblocks which only exist in the base layer. The sum TotalCoeff(coeff_token)+TotalCoeff(enh_coeff_token) is used as context to decode the inter macroblocks in the enhancement layer.

Enhancement Layer Inter Macroblock Decoding

For inter MBs, except skipped MBs, if implemented, the residual information may be encoded at both the base and the enhancement layer. Consequently, two entropy decodings are applied for each MB, e.g., as illustrated in FIG. 5. Assuming both layers have non-zero coefficients for an MB, context information of neighboring MBs is provided at both layers to decode coeff_token. Each layer has its own context information.

After entropy decoding, some information is saved for the entropy decoding of other MBs and deblocking. If base layer video decoding is performed, the base layer decoded TotalCoeff(coeff_token) is saved. If enhancement layer video decoding is performed, the base layer decoded TotalCoeff(coeff_token) and the enhancement layer decoded TotalCoeff(enh_coeff_token) are saved separately.

The parameter TotalCoeff(coeff_token) is used as context to decode the base layer MB coeff_token including intra MBs which only exist in the base layer. The sum of the base layer TotalCoeff(coeff_token) and the enhancement layer TotalCoeff(enh_coeff_token) is used as context to decode the inter MBs in the enhancement layer. In addition, this sum can also used as a parameter for deblocking the enhancement layer video.

Since dequantization involves intensive computation, the coefficients from two layers may be combined in a general purpose microprocessor before dequantization so that the hardware core performs the dequantization once for each MB with one QP. Both layers can be combined in the microprocessor, e.g., as described in the following section.

Coded Block Pattern (CBP) Decoding

The enhancement layer macroblock cbp, enh_coded_block_pattern, indicates code block patterns for inter-coded blocks in the enhancement layer video data. In some instances, enh_coded_block_pattern may be shortened to enh cbp, e.g., in Tables 12-15 below. For CBP decoding with high compression efficiency, the enhancement layer macroblock cbp, enh_coded_block_pattern, may be encoded in two different ways depending on the co-located base layer MB cbp base_coded_block_pattern.

For Case 1, in which base_coded_block_pattern=0, enh_coded_block_pattern may be encoded in compliance with the H.264 standard, e.g., in the same way as the base layer. For Case 2, in which base_coded_block_pattern≠0, the following approach can be used to convey the enh_coded_block_pattern. This approach may include three steps:

Step 1. In this step, for each luma 8×8 block where its corresponding base layer coded_block_pattern bit is equal to 1, fetch one bit. Each bit is the enh_coded_block_pattern bit for the enhancement layer co-located 8×8 block. The fetched bit may be referred to as the refinement bit. It should be noted that 8×8 block is used as an example for the purposes of explanation. Therefore, other blocks of different size are applicable.

Step 2. Based on the number of nonzero luma 8×8 blocks and chroma block cbp at the base layer, there are 9 combinations as shown in Table 12 below. Each combination is a context for the decoding of the remaining enh_coded_block_pattern information. In Table 12, cbp_{b,C} stands for the base layer chroma cbp and 93 cbp_{b,Y}(b8) represents the number of nonzero base layer luma 8×8 blocks. The cbp_{e,C} and cbp_{e,Y} columns show the new cbp format for the uncoded enh_coded_block_pattern information, except contexts 4 and 9. In cbp_{e,Y}, “x” stands for one bit for a luma 8×8 block, while in cbp_{e,C}, “xx” stands for 0, 1 or 2.

The code tables for decoding enh_coded_block_pattern based on the different contexts are specified in Tables 13 and 14 below.

Step 3. For contexts 4 and 9, enh_chroma_coded_block_pattern (which may be shortened to enh_chroma_cbp) is decoded separately by using the codebook in Table 15 below.

TABLE 12
Contexts used for decoding of enh_coded_block_pattern (enh_cbp)

| context | cbp_{b, C} | Σ cbp_{b, Y}(b8) | cbp_{e, C} | cbp_{e, Y} | num of symbols |
|---|---|---|---|---|---|
| 1 | 0 | 1 | xx | xxx | 24 |
| 2 | 0 | 2 | xx | xx | 12 |
| 3 | 0 | 3 | xx | x | 6 |
| 4 | 0 | 4 | n/a | n/a | |
| 5 | 1, 2 | 0 | | xxxx | 16 |
| 6 | 1, 2 | 1 | | xxx | 8 |
| 7 | 1, 2 | 2 | | xx | 4 |
| 8 | 1, 2 | 3 | | x | 2 |
| 9 | 1, 2 | 4 | n/a | n/a | |

The codebooks for different contexts are shown in Tables 13 and 14 below. These codebooks are based on statistic information over 27 MPEG2 decoded sequences.

TABLE 13
Huffman codewords for context 1–3 for enh_coded_block_pattern (enh_cbp)

| | context 1 | | context 2 | | context 3 | |
|---|---|---|---|---|---|---|
| symbol | code | enh_cbp | code | enh_cbp | code | enh_cbp |
| 0 | 10 | 0 | 11 | 0 | 0 | 1 |
| 1 | 001 | 1 | 00 | 3 | 10 | 0 |
| 2 | 011 | 4 | 100 | 1 | 111 | 3 |
| 3 | 1110 | 2 | 011 | 2 | 1101 | 2 |
| 4 | 0001 | 3 | 1011 | 4 | 1100 0 | 4 |
| 5 | 0100 | 5 | 0101 | 7 | 1100 1 | 5 |
| 6 | 0000 | 6 | 1010 0 | 5 | | |
| 7 | 1100 | 7 | 1010 1 | 6 | | |
| 8 | 0101 | 8 | 0100 0 | 8 | | |
| 9 | 1101 10 | 10 | 0100 10 | 11 | | |
| 10 | 1111 00 | 12 | 0100 111 | 10 | | |
| 11 | 1101 11 | 15 | 0100 110 | 9 | | |
| 12 | 1111 01 | 9 | | | | |
| 13 | 1111 110 | 11 | | | | |
| 14 | 1111 111 | 13 | | | | |
| 15 | 1111 101 | 14 | | | | |
| 16 | 1101 011 | 16 | | | | |
| 17 | 1101 001 | 23 | | | | |
| 18 | 1101 0101 | 17 | | | | |
| 19 | 1111 1000 | 18 | | | | |
| 20 | 1101 0000 | 19 | | | | |
| 21 | 1111 1001 | 20 | | | | |
| 22 | 1101 0100 | 21 | | | | |
| 23 | 1101 0001 | 22 | | | | |

TABLE 14
Huffman codewords for context 5–7 for enh_coded_block_pattern (enh_cbp)

| | context 5 | | context 6 | | context 7 | | context 8 | |
|---|---|---|---|---|---|---|---|---|
| symbol | code | enh_cbp | code | enh_cbp | code | enh_cbp | code | enh_cbp |
| 0 | 1 | 0 | 01 | 0 | 10 | 0 | 0 | 0 |
| 1 | 0000 | 4 | 101 | 1 | 00 | 1 | 1 | 1 |
| 2 | 0010 | 8 | 001 | 2 | 01 | 2 | | |
| 3 | 0111 0 | 1 | 100 | 4 | 11 | 3 | | |
| 4 | 0101 0 | 10 | 000 | 5 | | | | |
| 5 | 0001 0 | 11 | 110 | 7 | | | | |
| 6 | 0101 1 | 12 | 1110 | 3 | | | | |
| 7 | 0011 1 | 13 | 1111 | 6 | | | | |
| 8 | 0001 1 | 14 | | | | | | |
| 9 | 0110 1 | 15 | | | | | | |
| 10 | 0111 1 | 2 | | | | | | |
| 11 | 0110 0 | 3 | | | | | | |
| 12 | 0100 1 | 5 | | | | | | |
| 13 | 0011 0 | 7 | | | | | | |
| 14 | 0100 00 | 6 | | | | | | |
| 15 | 0100 01 | 9 | | | | | | |

Step 3. For contexts 4-9, chroma enh_cbp may be decoded separately by using the codebook shown in Table 15 below.

TABLE 15
Codeword for
enh_chroma_coded_block_pattern (ehn_chroma_cbp)

| enh_chroma_cbp | code |
|---|---|
| 0 | 0 |
| 1 | 10 |
| 2 | 11 |

Derivation Process for Quantization Parameters

A derivation process for quantization parameters (QPs) will now be described. Syntax element mb_qp_delta for each macroblock conveys the macroblock QP. The nominal base layer QP, QPb is also the QP used for quantization at the base layer specified using mb_qp_delta in the macroblocks in base_layer_slice. The nominal enhancement layer QP, QPe is also the QP used for quantization at the enhancement layer specified using mb_qp_delta in the enh_macroblock_layer. For QP derivation, to save bits, the QP difference between the base and enhancement layers may be kept constant instead of sending mb_qp_delta for each enhancement layer macroblock. In this way, the QP difference mb_qp_delta between the two layers is only sent on a frame basis.

Based on QP_{b} and QPₑ, a difference QP called delta_layer_qp is defined as:

delta_layer_{—}qp=QP_{b}−QPₑ

The quantization QP QP_{e.Y} used for the enhancement layer is derived based on two factors: (a) the existence of non-zero coefficient levels at the base layer and (b) delta_layer_qp. In order to facilitate a single de-quantization operation for the enhancement layer coefficients, delta_layer_qp may be restricted such that delta_layer_qp%6=0. Given these two quantities, the QP is derived as follows:

1. If the base layer co-located MB has no non-zero coefficient, nominal QPₑ will be used, since only the enhancement coefficients need to be decoded.

QP_{e.Y}=QP_{e.}

2. If delta_layer_qp%6=0, QPₑ is still used for the enhancement layer, no matter whether there are non-zero coefficients or not. This is based on the fact that the quantization step size doubles for every increment of 6 in QP.

The following operation describes the inverse quantization process (denoted as Q⁻¹) to merge the base layer and the enhancement layer coefficients, defined as C_{b} and Cₑ, respectively,

Fₑ=Q⁻¹((C_{b}(QP_{b})<<(delta_layer_{—}qp/6))+Cₑ(QPₑ))

where Fₑ denotes inverse quantized enhancement layer coefficients and Q⁻¹ indicates an inverse quantization function.

If the base layer co-located macroblock has non-zero coefficient and delta_layer_qp%6≠0, inverse quantization of base and enhancement layer coefficients use QP_{b} and QPₑ respectively. The enhancement layer coefficients are derived as follows:

Fₑ=Q⁻¹(C_{b}(QP_{b}))+Q⁻¹(Cₑ(QPₑ))

The derivation of the chroma QPs (QP_{base,C} and QP_{enh,C}) is based on the luma QPs (QP_{b,Y} and QP_{e,Y}). First, compute qP_{I} as follows:

qP_{I}=Clip3(0, 51, QP_{x,Y}+chroma_{—}qp_index_offset)

where x stands for “b” for base or “e” for enhancement, chroma_qp_index_offset is defined in the picture parameter set, and Clip3 is the following mathematical function:

$$Clip 3 ( x , y , z ) = \{ \begin{matrix}x ; z < x \\ y ; z > y \\ z ; otherwise\end{matrix}$$

The value of QP_{x,C} may be determined as specified in Table 16 below.

TABLE 16
Specification of QP_{x,C} as a function qP_{I}

| | qP_{I} | | | | | | | | | | | | | | | | | | | | | | |
|---|---|---|---|---|---|---|---|---|---|---|---|---|---|---|---|---|---|---|---|---|---|---|---|
| | <30 | 30 | 31 | 32 | 33 | 34 | 35 | 36 | 37 | 38 | 39 | 40 | 41 | 42 | 43 | 44 | 45 | 46 | 47 | 48 | 49 | 50 | 51 |
| QP_{x, C} | qP_{I} | 29 | 30 | 31 | 32 | 32 | 33 | 34 | 34 | 35 | 35 | 36 | 36 | 37 | 37 | 37 | 38 | 38 | 38 | 39 | 39 | 39 | 39 |

### For the enhancement layer video, MB QPs derived during the dequantization are used in deblocking.

Deblocking

For deblocking, a deblock filter may be applied to all 4×4 block edges of a frame, except edges at the boundary of the frame and any edges for which the deblocking filter process is disabled by disable_deblocking_filter_idc. This filtering process is performed on a macroblock (MB) basis after the completion of the frame construction process with all macroblocks in a frame processed in order of increasing macroblock addresses.

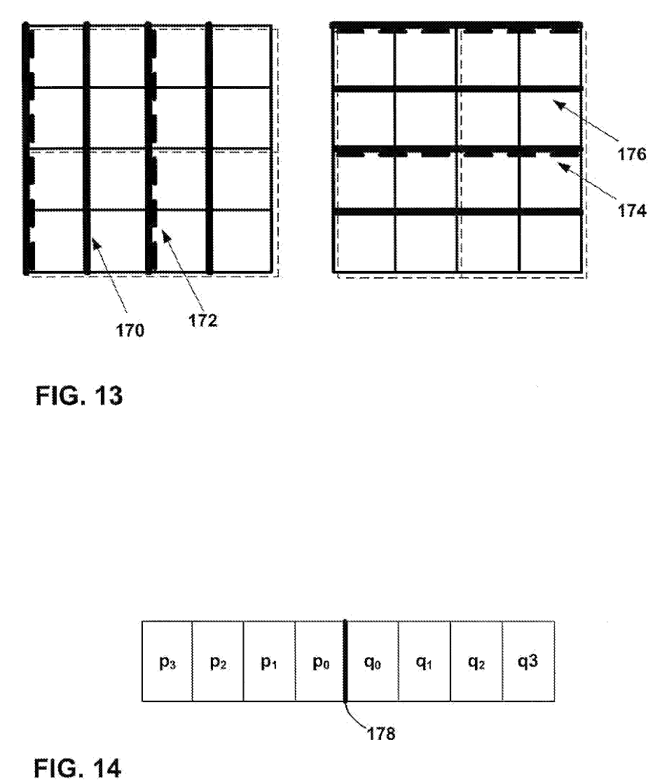

FIG. 13 is a diagram illustrating a luma and chroma deblocking filter process. The deblocking filter process is invoked for the luma and chroma components separately. For each macroblock, vertical edges are filtered first, from left to right, and then horizontal edges are filtered from top to bottom. For a 16×16 macroblock, the luma deblocking filter process is performed on four 16-sample edges, and the deblocking filter process for each chroma component is performed on two 8-sample edges, for the horizontal direction and for the vertical direction, e.g., as shown in FIG. 13. Luma boundaries in a macroblock to be filtered are shown with solid lines in FIG. 13. FIG. 13 shows chroma boundaries in a macroblock to be filtered with dashed lines.

In FIG. 13, reference numerals 170, 172 indicate vertical edges for luma and chroma filtering, respectively. Reference numerals 174, 176 indicate horizontal edges for luma and chroma filtering, respectively. Sample values above and to the left of a current macroblock that may have already been modified by the deblocking filter process operation on previous macroblocks are used as input to the deblocking filter process on the current macroblock and may be further modified during the filtering of the current macroblock. Sample values modified during filtering of vertical edges are used as input for the filtering of the horizontal edges for the same macroblock.

In the H.264 standard, MB modes, the number of non-zero transform coefficient levels and motion information are used to decide the boundary filtering strength. MB QPs are used to obtain the threshold which indicates whether the input samples are filtered. For the base layer deblocking, these pieces of information are straightforward. For the enhancement layer video, proper information is generated. In this example, the filtering process is applied to a set of eight samples across a 4×4 block horizontal or vertical edge denoted as pᵢ and qᵢ with i=0, 1, 2, or 3 as shown in FIG. 14, with the edge 178 lying between p₀ and q₀. FIG. 14 specifies pᵢ and qᵢ with i=0 to 3.

The decoding of an enhancement I frame may require a decoded base layer I frame and adding interlayer predicted residual. A deblocking filter is applied on the reconstructed base layer I frame before being used to predict the enhancement layer I frame. Application of the standard technique for I frame deblocking to deblock the enhancement layer I frame may be undesirable. As an alternative, the following criteria can be used to derive boundary filtering strength (bS). The variable bS can be derived as follows. The value of bS is set to 2 if either of the following conditions are true:
a. The 4×4 luma block containing sample p₀ contains non-zero transform coefficient levels and is in a macroblock coded using an intra 4×4 macroblock prediction mode; or
b. The 4×4 luma block containing sample q₀ contains non-zero transform coefficient levels and is in a macroblock coded using an intra 4×4 macroblock prediction mode.

### If neither of the above conditions is true, then the bS value is set to equal 1.

For P frames, the residual information of inter MBs, except skipped MBs can be encoded at both the base and the enhancement layer. Because of single decoding, coefficients from two layers are combined. Because the number of non-zero transform coefficient levels is used to decide the boundary strength in deblocking, it is important to define how to calculate the number of non-zero transform coefficients levels of each 4×4 block at the enhancement layer to be used at deblocking. Improperly increasing or decreasing the number could either over-smooth the picture or cause blockiness. The variable bS is derived as follows:

1. If the block edge is also a macroblock edge and the samples p₀ and q₀ are both in frame macroblocks, and either of the samples p₀ or q₀ is in a macroblock coded using an intra macroblock prediction mode, then the value for bS is 4.

2. Otherwise, if either of the samples p0 or q0 is in a macroblock coded using an intra macroblock prediction mode, then the value for bS is 3.

3. Otherwise, if, at the base layer, the 4×4 luma block containing sample p0 or the 4×4 luma block containing sample q0 contains non-zero transform coefficient levels, or, at the enhancement layer, the 4×4 luma block containing sample p0 or the 4×4 luma block containing sample q0 contains non-zero transform coefficient levels, then the value for bS is 2.

4. Otherwise, output a value of 1 for bS, or alternatively use the standard approach.

Channel Switch Frames

A channel switch frame may encapsulated in one or more supplemental enhancement information (SEI) NAL Units, and may be referred to as an SEI Channel Switch Frame (CSF). In one example, the SEI CSF has a payloadTypefield equal to 22. The RBSP syntax for the SEI message is as specified in 7.3.2.3 of the H.264 standard. SEI RBSP and SEI CSF message syntax may be provided as set forth in Tables 17 and 18 below.

TABLE 17
SEI RBSP Syntax

| sei_rbsp( ) { | C | Descriptor |
|---|---|---|
| do | | |
| sei_message( ) | 5 | |
| while(more_rbsp_data( )) | | |
| rbsp_trailing_bits( ) | 5 | |
| } | | |

TABLE 18
SEI CSF message syntax

| sei_message( ) { | C | Descriptor |
|---|---|---|
| 22 /* payloadType */ | 5 | f(8) |
| payloadlype = 22 | | |
| payloadSize = 0 | | |
| while(next_bits(8) == 0xFF) { | | |
| ff_byte /* equal to 0xFF */ | 5 | f(8) |
| payloadSize += 255 | | |
| } | | |
| last_payload_size_byte | 5 | u(8) |
| payloadSize += last_payload_size_byte | | |
| channel_switch_frame_slice_data | 5 | |
| } | | |

The syntax of channel switch frame slice data may be identical to that of a base layer I slice or P slice which is specified in clause 7 of the H.264 standard. The channel switch frame (CSF) can be encapsulated in an independent transport protocol packet to enable visibility into random access points in the coded bitstream. There is no restriction on the layer to communicate the channel switch frame. It may be contained either in the base layer or the enhancement layer.

For channel switch frame decoding, if a channel change request is initiated, the channel switch frame in the requested channel will be decoded. If the channel switch frame is contained in a SEI CSF message, the decoding process used for the base layer I slice will be used to decode the SEI CSF. The P slice coexisting with the SEI CSF will not be decoded and the B pictures with output order in front of the channel switch frame are dropped. There is no change to the decoding process of future pictures (in the sense of output order).

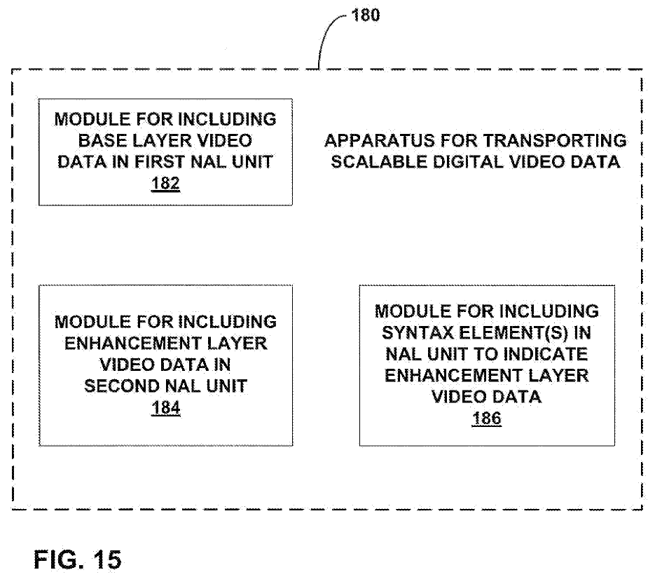

FIG. 15 is a block diagram illustrating a device 180 for transporting scalable digital video data with a variety of exemplary syntax elements to support low complexity video scalability. Device 180 includes a module 182 for including base layer video data in a first NAL unit, a module 184 for including enhancement layer video data in a second NAL unit, and a module 186 for including one or more syntax elements in at least one of the first and second NAL units to indicate presence of enhancement layer video data in the second NAL unit. In one example, device 180 may form part of a broadcast server 12 as shown in FIGS. 1 and 3, and may be realized by hardware, software, or firmware, or any suitable combination thereof. For example, module 182 may include one or more aspects of base layer encoder 32 and NAL unit module 23 of FIG. 3, which encode base layer video data and include it in a NAL unit. In addition, as an example, module 184 may include one or more aspects of enhancement layer encoder 34 and NAL unit module 23, which encode enhancement layer video data and include it in a NAL unit. Module 186 may include one or more aspects of NAL unit module 23, which includes one or more syntax elements in at least one of a first and second NAL unit to indicate presence of enhancement layer video data in the second NAL unit. In one example, the one or more syntax elements are provided in the second NAL unit in which the enhancement layer video data is provided.

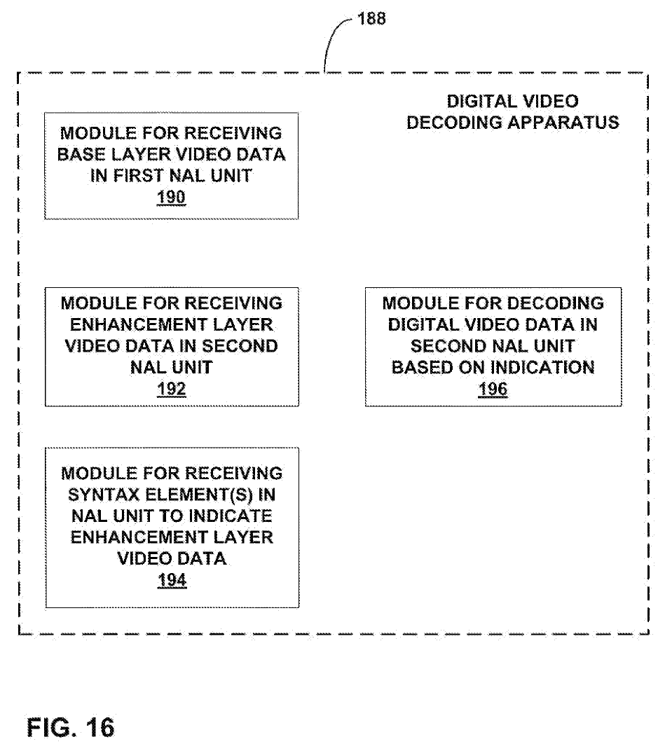

FIG. 16 is a block diagram illustrating a digital video decoding apparatus 188 that decodes a scalable video bitstream to process a variety of exemplary syntax elements to support low complexity video scalability. Digital video decoding apparatus 188 may reside in a subscriber device, such as subscriber device 16 of FIG. 1 or FIG. 3. video decoder 14 of FIG. 1, and may be realized by hardware, software, or firmware, or any suitable combination thereof. Apparatus 188 includes a module 190 for receiving base layer video data in a first NAL unit, a module 192 for receiving enhancement layer video data in a second NAL unit, a module 194 for receiving one or more syntax elements in at least one of the first and second NAL units to indicate presence of enhancement layer video data in the second NAL unit, and a module 196 for decoding the digital video data in the second NAL unit based on the indication provided by the one or more syntax elements in the second NAL unit. In one aspect, the one or more syntax elements are provided in the second NAL unit in which the enhancement layer video data is provided. As an example, module 190 may include receiver/demodulator 26 of subscriber device 16 in FIG. 3. In this example, module 192 also may include receiver/demodulator 26. Module 194, in some example configurations, may include a NAL unit module such as NAL unit module 27 of FIG. 3, which processes syntax elements in the NAL units. Module 196 may include a video decoder, such as video decoder 28 of FIG. 3.

The techniques described herein may be implemented in hardware, software, firmware, or any combination thereof. If implemented in software, the techniques may be realized at least in part by one or more stored or transmitted instructions or code on a computer-readable medium. Computer-readable media may include computer storage media, communication media, or both, and may include any medium that facilitates transfer of a computer program from one place to another. A storage media may be any available media that can be accessed by a computer.

By way of example, and not limitation, such computer-readable media can comprise RAM, such as synchronous dynamic random access memory (SDRAM), read-only memory (ROM), non-volatile random access memory (NVRAM), ROM, electrically erasable programmable read-only memory (EEPROM), EEPROM, FLASH memory, CD-ROM or other optical disk storage, magnetic disk storage or other magnetic storage devices, or any other medium that can be used to carry or store desired program code in the form of instructions or data structures and that can be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically, e.g., with lasers. Combinations of the above should also be included within the scope of computer-readable media.

The code associated with a computer-readable medium of a computer program product may be executed by a computer, e.g., by one or more processors, such as one or more digital signal processors (DSPs), general purpose microprocessors, application specific integrated circuits (ASICs), field programmable logic arrays (FPGAs), or other equivalent integrated or discrete logic circuitry. In some aspects, the functionality described herein may be provided within dedicated software modules or hardware modules configured for encoding and decoding, or incorporated in a combined video encoder-decoder (CODEC).

Various aspects have been described. These and other aspects are within the scope of the following claims.

1. A method for transporting scalable digital video data, the method comprising:
including enhancement layer video data in a network abstraction layer (NAL) unit; and
including one or more syntax elements in the NAL unit to indicate whether the NAL unit includes enhancement layer video data.

2. The method of claim 1, further comprising including one or more syntax elements in the NAL unit to indicate a type of raw byte sequence payload (RBSP) data structure of the enhancement layer data in the NAL unit.

3. The method of claim 1, further comprising including one or more syntax elements in the NAL unit to indicate whether the enhancement layer video data in the NAL unit includes intra-coded video data.

4. The method of claim 1, wherein the NAL unit is a first NAL unit, the method further comprising including base layer video data in a second NAL unit, and including one or more syntax elements in at least one of the first and second NAL units to indicate whether a decoder should use pixel domain or transform domain addition of the enhancement layer video data with the base layer video data.

5. The method of claim 1, wherein the NAL unit is a first NAL unit, the method further comprising including base layer video data in a second NAL unit, and including one or more syntax elements in at least one of the first and second NAL units to indicate whether the enhancement layer video data includes any residual data relative to the base layer video data.

6. The method of claim 1, further comprising including one or more syntax elements in the NAL unit to indicate whether the NAL unit includes a sequence parameter, a picture parameter set, a slice of a reference picture or a slice data partition of a reference picture.

7. The method of claim 1, further comprising including one or more syntax elements in the NAL unit to identify blocks within the enhancement layer video data containing non-zero transform coefficient syntax elements.

8. The method of claim 1, further comprising including one or more syntax elements in the NAL unit to indicate a number of nonzero coefficients in intra-coded blocks in the enhancement layer video data with a magnitude larger than one.

9. The method of claim 1, further comprising including one or more syntax elements in the NAL unit to indicate coded block patterns for inter-coded blocks in the enhancement layer video data.

10. The method of claim 1, wherein the NAL unit is a first NAL unit, the method further comprising including base layer video data in a second NAL unit, and wherein the enhancement layer video data is encoded to enhance a signal-to-noise ratio of the base layer video data.

11. The method of claim 1, wherein including one or more syntax elements in the NAL unit to indicate whether the NAL unit includes enhancement layer video data comprises setting a NAL unit type parameter in the NAL unit to a selected value to indicate that the NAL unit includes enhancement layer video data.

12. An apparatus for transporting scalable digital video data, the apparatus comprising:
a network abstraction layer (NAL) unit module that includes encoded enhancement layer video data in a NAL unit, and includes one or more syntax elements in the NAL unit to indicate whether the NAL unit includes enhancement layer video data.

13. The apparatus of claim 12, wherein the NAL unit module includes one or more syntax elements in the NAL unit to indicate a type of raw byte sequence payload (RBSP) data structure of the enhancement layer data in the NAL unit.

14. The apparatus of claim 12, wherein the NAL unit module includes one or more syntax elements in the NAL unit to indicate whether the enhancement layer video data in the NAL unit includes intra-coded video data.

15. The apparatus of claim 12, wherein the NAL unit is a first NAL unit, wherein the NAL unit module incluees base layer video data in a second NAL unit, and wherein the NAL unit module includes one or more syntax elements in at least one of the first and second NAL units to indicate whether a decoder should use pixel domain or transform domain addition of the enhancement layer video data with the base layer video data.

16. The apparatus of claim 12, wherein the NAL unit is a first NAL unit, the NAL unit module includes base layer video data in a second NAL unit, and wherein the NAL unit module includes one or more syntax elements in at least one of the first and second NAL units to indicate whether the enhancement layer video data includes any residual data relative to the base layer video data.

17. The apparatus of claim 12, wherein the NAL unit module includes one or more syntax elements in the NAL unit to indicate whether the NAL unit includes a sequence parameter, a picture parameter set, a slice of a reference picture or a slice data partition of a reference picture.

18. The apparatus of claim 12, wherein the NAL unit module includes one or more syntax elements in the NAL unit to identify blocks within the enhancement layer video data containing non-zero transform coefficient syntax elements.

19. The apparatus of claim 12, wherein the NAL unit module includes one or more syntax elements in the NAL unit to indicate a number of nonzero coefficients in intra-coded blocks in the enhancement layer video data with a magnitude larger than one.

20. The apparatus of claim 12, wherein the NAL unit module includes one or more syntax elements in the NAL unit to indicate coded block patterns for inter-coded blocks in the enhancement layer video data.

21. The apparatus of claim 12, wherein the NAL unit is a first NAL unit, the NAL unit module includes base layer video data in a second NAL unit, and wherein the encoder encodes the enhancement layer video data to enhance a signal-to-noise ratio of the base layer video data.

22. The apparatus of claim 12, wherein the NAL unit module sets a NAL unit type parameter in the NAL unit to a selected value to indicate that the NAL unit includes enhancement layer video data.

23. A processor for transporting scalable digital video data, the processor being configured to include enhancement layer video data in a network abstraction layer (NAL) unit, and include one or more syntax elements in the NAL unit to indicate whether the NAL unit includes enhancement layer video data.

24. An apparatus for transporting scalable digital video data, the method comprising:
means for including enhancement layer video data in a network abstraction layer (NAL) unit; and
means for including one or more syntax elements in the NAL unit to indicate whether the NAL unit includes enhancement layer video data.

25. The apparatus of claim 24, further comprising means for including one or more syntax elements in the NAL unit to indicate a type of raw byte sequence payload (RBSP) data structure of the enhancement layer data in the NAL unit.

26. The apparatus of claim 24, further comprising means for including one or more syntax elements in the NAL unit to indicate whether the enhancement layer video data in the NAL unit includes intra-coded video data.

27. The apparatus of claim 24, wherein the NAL unit is a first NAL unit, the apparatus further comprising means for including base layer video data in a second NAL unit, and means for including one or more syntax elements in at least one of the first and second NAL units to indicate whether a decoder should use pixel domain or transform domain addition of the enhancement layer video data with the base layer video data.

28. The apparatus of claim 24, wherein the NAL unit is a first NAL unit, the apparatus further comprising means for including base layer video data in a second NAL unit, and means for including one or more syntax elements in at least one of the first and second NAL units to indicate whether the enhancement layer video data includes any residual data relative to the base layer video data.

29. The apparatus of claim 24, further comprising means for including one or more syntax elements in the NAL unit to indicate whether the NAL unit includes a sequence parameter, a picture parameter set, a slice of a reference picture or a slice data partition of a reference picture.

30. The apparatus of claim 24, further comprising means for including one or more syntax elements in the NAL unit to identify blocks within the enhancement layer video data containing non-zero transform coefficient syntax elements.

31. The apparatus of claim 24, further comprising means for including one or more syntax elements in the NAL unit to indicate a number of nonzero coefficients in intra-coded blocks in the enhancement layer video data with a magnitude larger than one.

32. The apparatus of claim 24, further comprising means for including one or more syntax elements in the NAL unit to indicate coded block patterns for inter-coded blocks in the enhancement layer video data.

33. The apparatus of claim 24, wherein the NAL unit is a first NAL unit, the apparatus further comprising means for including base layer video data in a second NAL unit, and wherein the enhancement layer video data enhances a signal-to-noise ratio of the base layer video data.

34. The apparatus of claim 24, wherein the means for including one or more syntax elements in the NAL unit to indicate whether the NAL unit includes enhancement layer video data comprises means for setting a NAL unit type parameter in the NAL unit to a selected value to indicate that the NAL unit includes enhancement layer video data.

35. A computer program product for transport of scalable digital video data comprising: a computer-readable medium comprising codes for causing a computer to:
include enhancement layer video data in a network abstraction layer (NAL) unit; and
include one or more syntax elements in the NAL unit to indicate whether the NAL unit includes enhancement layer video data.

36. A method for processing scalable digital video data, the method comprising:
receiving enhancement layer video data in a network abstraction layer (NAL) unit;
receiving one or more syntax elements in the NAL unit to indicate whether the NAL unit includes enhancement layer video data; and
decoding the digital video data in the NAL unit based on the indication.

37. The method of claim 36, further comprising detecting one or more syntax elements in the NAL unit to determine a type of raw byte sequence payload (RBSP) data structure of the enhancement layer data in the NAL unit.

38. The method of claim 36, further comprising detecting one or more syntax elements in the NAL unit to determine whether the enhancement layer video data in the NAL unit includes intra-coded video data.

39. The method of claim 36, wherein the NAL unit is a first NAL unit, the method further comprising:
receiving base layer video data in a second NAL unit;
detecting one or more syntax elements in at least one of the first and second NAL units to determine whether the enhancement layer video data includes any residual data relative to the base layer video data; and
skipping decoding of the enhancement layer video data if it is determined that the enhancement layer video data includes no residual data relative to the base layer video data.

40. The method of claim 36, wherein the NAL unit is a first NAL unit, the method further comprising:
receiving base layer video data in a second NAL unit;
detecting one or more syntax elements in at least one of the first and second NAL units to determine whether the first NAL unit includes a sequence parameter, a picture parameter set, a slice of a reference picture or a slice data partition of a reference picture;
detecting one or more syntax elements in at least one of the first and second NAL units to identify blocks within the enhancement layer video data containing non-zero transform coefficient syntax elements; and
detecting one or more syntax elements in at least one of the first and second NAL units to determine whether pixel domain or transform domain addition of the enhancement layer video data with the base layer data should be used to decode the digital video data

41. The method of claim 36, further comprising detecting one or more syntax elements in the NAL unit to determine a number of nonzero coefficients in intra-coded blocks in the enhancement layer video data with a magnitude larger than one.

42. The method of claim 36, further comprising detecting one or more syntax elements in the NAL unit to determine coded block patterns for inter-coded blocks in the enhancement layer video data.

43. The method of claim 36, wherein the NAL unit is a first NAL unit, the method further comprising including base layer video data in a second NAL unit, and wherein the enhancement layer video data is encoded to enhance a signal-to-noise ratio of the base layer video data.

44. The method of claim 36, wherein receiving one or more syntax elements in the NAL unit to indicate whether the NAL unit includes enhancement layer video data comprises receiving a NAL unit type parameter in the NAL unit that is set to a selected value to indicate that the NAL unit includes enhancement layer video data.

45. An apparatus for processing scalable digital video data, the apparatus comprising:
a network abstraction layer (NAL) unit module that receives enhancement layer video data in a NAL unit, and receives one or more syntax elements in the NAL unit to indicate whether the NAL unit includes enhancement layer video data; and
a decoder that decodes the digital video data in the NAL unit based on the indication.

46. The apparatus of claim 45, wherein the NAL unit module detects one or more syntax elements in the NAL unit to determine a type of raw byte sequence payload (RBSP) data structure of the enhancement layer data in the NAL unit.

47. The apparatus of claim 45, wherein the NAL unit module detects one or more syntax elements in the NAL unit to determine whether the enhancement layer video data in the NAL unit includes intra-coded video data.

48. The apparatus of claim 45, wherein the NAL unit is a first NAL unit, wherein the NAL unit module receives base layer video data in a second NAL unit, and wherein the NAL unit module detects one or more syntax elements in at least one of the first and second NAL units to determine whether the enhancement layer video data includes any residual data relative to the base layer video data, and the decoder skips decoding of the enhancement layer video data if it is determined that the enhancement layer video data includes no residual data relative to the base layer video data.

49. The apparatus of claim 45, wherein the NAL unit is a first NAL unit, wherein the NAL unit module:
receives base layer video data in a second NAL unit;
detects one or more syntax elements in at least one of the first and second NAL units to determine whether the first NAL unit includes a sequence parameter, a picture parameter set, a slice of a reference picture or a slice data partition of a reference picture;
detects one or more syntax elements in at least one of the first and second NAL units to identify blocks within the enhancement layer video data containing non-zero transform coefficient syntax elements; and
detects one or more syntax elements in at least one of the first and second NAL units to determine whether pixel domain or transform domain addition of the enhancement layer video data with the base layer data should be used to decode the digital video data.

50. The apparatus of claim 45, wherein the NAL processing module detects one or more syntax elements in the NAL unit to determine a number of nonzero coefficients in intra-coded blocks in the enhancement layer video data with a magnitude larger than one.

51. The apparatus of claim 45, wherein the NAL processing module detects one or more syntax elements in the NAL unit to determine coded block patterns for inter-coded blocks in the enhancement layer video data.

52. The apparatus of claim 45, wherein the NAL unit is a first NAL unit, the NAL unit module including base layer video data in a second NAL unit, and wherein the enhancement layer video data is encoded to enhance a signal-to-noise ratio of the base layer video data.

53. The apparatus of claim 45, wherein the NAL unit module receives a NAL unit type parameter in the NAL unit that is set to a selected value to indicate that the NAL unit includes enhancement layer video data.

54. A processor for processing scalable digital video data, the processor being configured to:
receive enhancement layer video data in a network abstraction layer (NAL) unit;
receive one or more syntax elements in the NAL unit to indicate whether the NAL unit includes enhancement layer video data; and
decode the digital video data in the NAL unit based on the indication.

55. An apparatus for processing scalable digital video data, the apparatus comprising:
means for receiving enhancement layer video data in a network abstraction layer (NAL) unit;
means for receiving one or more syntax elements in the NAL unit to indicate whether the NAL unit includes enhancement layer video data; and
means for decoding the digital video data in the NAL unit based on the indication.

56. The apparatus of claim 55, further comprising means for detecting one or more syntax elements in the NAL unit to determine a type of raw byte sequence payload (RBSP) data structure of the enhancement layer data in the NAL unit.

57. The apparatus of claim 55, further comprising means for detecting one or more syntax elements in the NAL unit to determine whether the enhancement layer video data in the NAL unit includes intra-coded video data.

58. The apparatus of claim 55, wherein the NAL unit is a first NAL unit, the apparatus further comprising:
means for receiving base layer video data in a second NAL unit;
means for detecting one or more syntax elements in at least one of the first and second NAL units to determine whether the enhancement layer video data includes any residual data relative to the base layer video data; and
means for skipping decoding of the enhancement layer video data if it is determined that the enhancement layer video data includes no residual data relative to the base layer video data.

59. The apparatus of claim 55, wherein the NAL unit is a first NAL unit, the apparatus further comprising:
means for receiving base layer video data in a second NAL unit;
means for detecting one or more syntax elements in at least one of the first and second NAL units to determine whether the first NAL unit includes a sequence parameter, a picture parameter set, a slice of a reference picture or a slice data partition of a reference picture;
means for detecting one or more syntax elements in at least one of the first and second NAL units to identify blocks within the enhancement layer video data containing non-zero transform coefficient syntax elements; and
means for detecting one or more syntax elements in at least one of the first and second NAL units to determine whether pixel domain or transform domain addition of the enhancement layer video data with the base layer data should be used to decode the digital video data

60. The apparatus of claim 55, further comprising means for detecting one or more syntax elements in the NAL unit to determine a number of nonzero coefficients in intra-coded blocks in the enhancement layer video data with a magnitude larger than one.

61. The apparatus of claim 55, further comprising means for detecting one or more syntax elements in the NAL unit to determine coded block patterns for inter-coded blocks in the enhancement layer video data.

62. The apparatus of claim 55, wherein the NAL unit is a first NAL unit, the apparatus further comprising means for including base layer video data in a second NAL unit, and wherein the enhancement layer video data is encoded to enhance a signal-to-noise ratio of the base layer video data.

63. The apparatus of claim 55, wherein the means for receiving one or more syntax elements in the NAL unit to indicate whether the respective NAL unit includes enhancement layer video data comprises means for receiving a NAL unit type parameter in the NAL unit that is set to a selected value to indicate that the NAL unit includes enhancement layer video data.

64. A computer program product for processing of scalable digital video data comprising: a computer-readable medium comprising codes for causing a computer to:
receive enhancement layer video data in a network abstraction (NAL) unit;
receive one or more syntax elements in the NAL unit to indicate whether the NAL unit includes enhancement layer video data; and
decode the digital video data in the NAL unit based on the indication.
